(19) United States
(12) Patent Application Publication
(10) Pub. No.: US 2026/0020009 A1
(43) Pub. Date: Jan. 15, 2026

(54) APPARATUS AND METHODS FOR AVOIDING INTERFERENCE FOR IN-DEVICE COEXISTENCE

(71) Applicant: Huawei Technologies Co., Ltd., Shenzhen (CN)

(72) Inventors: Jagdeep Singh Ahluwalia, Reading (GB); Haibo Xu, Beijing (CN)

(21) Appl. No.: 19/330,031

(22) Filed: Sep. 16, 2025

Related U.S. Application Data
(63) Continuation of application No. PCT/CN2023/093778, filed on May 12, 2023.

(30) Foreign Application Priority Data
Mar. 17, 2023 (WO) PCT/CN2023/082314

(51) Int. Cl. H04W 72/0453; H04L 5/00; H04W 28/20; H04W 76/15

(52) U.S. Cl. CPC H04W 72/0453; H04W 28/20; H04L 5/0073; H04W 76/15

(57) ABSTRACT

In some examples, master node (MN), in a telecommunication network, wherein the telecommunication network further comprises a secondary node (SN) and a user equipment (UE), and wherein the UE, is operable in dual connectivity (DC), with the MN, and with the SN, such that the UE, can transmit and receive data on multiple carriers of the MN, and the SN, is configured to receive, from the UE, data representing an indication of a set of carrier frequencies and/or a set of carrier frequency ranges or a combination of candidate serving frequencies or frequency ranges, wherein the MN is further configured to use a configuration, on the basis of the data received from the UE, by the SN, of the telecommunications network, for time division multiplexing (TDM), or frequency division multiplexing (FDM), whereby to mitigate the effects of the IDC.

### CROSS-REFERENCE TO RELATED APPLICATIONS

This application is a continuation of International Application No. PCT/CN2023/093778, filed on May 12, 2023, which claims priority to claims priority to International Application No. PCT/CN2023/082314, filed on Mar. 17, 2023. The disclosures of the aforementioned applications are hereby incorporated by reference in their entireties.

### TECHNICAL FIELD

The present disclosure relates, in general, to data transmission in a communications network, in particular to avoiding interference between signals from one or more diverse radio techniques used in user equipment such as smartphones.

### BACKGROUND

Increasing demand for multiple applications or services in user equipment (UE) has resulted the coexistence of multiple collocated radio technologies within UE devices. That is, UE can be equipped with multiple radio transceivers to enable communication using multiple diverse radio protocols such as Long Term Evolution (LTE), New Radio (NR), Global Positioning System (GPS), WiFi and Bluetooth. As a result of this, and due to more frequency bands being introduced for both NR and LTE, in-device coexistence (IDC) has become a serious problem due to the proximity of the multiple radio transceivers within the same device. IDC as a result of multiple collocated radio technologies can cause interference, referred to as in-device interference, between transceivers as a result of their physical proximity, spectral closeness, and/or imperfect radio frequency (RF) filtering.

In situations where a UE is operating in a dual connectivity mode in which it can be in simultaneous communication using multiple radio access technologies (RATs), known as multi-RAT Dual Connectivity (MR-DC), the UE can be connected to two network nodes simultaneously, one of which can be provided as part of a 3rd Generation Partnership Project (3GPP) 5G network (e.g., NR) and one of which can be provided as part of a 4G 3GPP network (e.g., EUTRA) or between two NR nodes. As such, 3GPP signals may be impacted by non-3GPP signals, and vice versa.

In order to mitigate in-device interference, previously defined solutions, for example using frequency division multiplexing (FDM), are generally aimed at switching the entire LTE or NR frequency away from, e.g., the Industrial, Scientific and Medical (ISM) radio frequency (RF) band (such as WiFi). FDM solutions are applicable to all scenarios as long as an alternate carrier frequency is available. In some network deployments, however, using FDM-based solutions to resolve IDC interference problems is not possible or desirable. Furthermore, a time division multiplex (TDM) solution is not presently available in the context of MR-DC where one of the RATs comprises, e.g., 5G NR.

### SUMMARY

An objective of the present disclosure is to provide apparatus and methods to mitigate against in-device interference in MR-DC scenarios such as, for example, where a UE is connected to two network nodes simultaneously both belonging to either NR or one belonging to NR and other belonging to E-UTRA.

The foregoing and other objectives are achieved by the features of the independent claims.

Further implementation forms are apparent from the dependent claims, the description and the Figures.

A first aspect of the present disclosure provides a master node, MN, in a telecommunication network, wherein the telecommunication network further comprises a secondary node, SN and a user equipment, UE, and wherein the user equipment, UE, is operable in dual connectivity, DC, with the master node, MN, and with the secondary node, SN, such that the user equipment, UE, can transmit and receive data on multiple carriers of the master node, MN, and the secondary node, SN, the master node, MN, being configured to receive, from the user equipment, UE, data representing an indication of a set of carrier frequencies and/or a set of carrier frequency ranges or a combination of candidate serving frequencies or frequency ranges of the master node, MN, and/or of the secondary node, SN, affected by in-device coexistence, IDC, for uplink and/or downlink communications between the master node, MN, and/or the secondary node, SN, and the user equipment, UE, wherein the master node, MN is further configured to use a configuration, determined on the basis of the data received from the user equipment, UE, by the master node, MN, and/or the secondary node, SN, of the telecommunications network, for time division multiplexing, TDM, or frequency division multiplexing, FDM, whereby to mitigate the effects of the in-device coexistence, IDC, for uplink and/or downlink communications between the master node, MN, and/or the secondary node, SN, and the user equipment, UE.

There is therefore coordination between nodes in an MR-DC scenario that enables in-device interference to be mitigated or removed. For example, coordination between a master node and a secondary node can enable a configuration to be generated that can be used by one or more of the master node, the secondary node and a user equipment to implement FDM or TDM aimed at (at least) reducing in-device interference at the UE. Accordingly, an IDC problem in MR-DC scenarios can be dealt with in terms of which nodes provides a configuration and how the FDM and TDM solution can be applied with internode coordination which will efficiently resolve the IDC problems for the UE operating in an MR-DC configuration.

In an implementation of the first aspect, the set of component carrier frequencies and/or the set of component carrier frequency ranges of the master node, MN, and/or the secondary node, SN affected by in-device coexistence, IDC, for uplink and/or downlink communications between the master node, MN, and/or the secondary node, SN, and the user equipment, UE can be configured by the master node, MN. The master node can transmit, to the secondary node, SN, the data representing the indication of the set of component carrier frequencies and/or the set of component carrier frequency ranges or a combination of candidate serving frequencies or frequency ranges of the master node, MN, and/or the secondary node, SN affected by in-device coexistence, IDC, for uplink and/or downlink communications between the master node, MN, and/or the secondary node, SN, and the user equipment, UE, wherein the set of component carrier frequencies and/or the set of component carrier frequency ranges or a combination of candidate serving frequencies or frequency ranges of the master node, MN, and/or the secondary node, SN affected by in-device coexistence, IDC, for uplink and/or downlink communications between the master node, MN, and/or the secondary node, SN, and the user equipment, UE is configured by the secondary node, SN.

In an example, the master node can deactivate a Secondary Cell, SCell, of the telecommunications network; and/or, switch to a different carrier bandwidth part, BWP, from a set of multiple available carrier bandwidth parts, BWPs, for uplink and/or downlink communications between the master node, MN, and the user equipment, UE; and/or restrict a physical resource block, PRB, allocation in an unaffected frequency range, whereby to resolve the in-device coexistence, IDC, for uplink and/or downlink communications between the master node, MN, and/or the secondary node, SN, and the user equipment, UE. The master node can receive, from the secondary node, SN, data representing an indication to enable time divisional multiplexing, TDM, for uplink and/or downlink communications between the master node, MN, and/or the secondary node, SN, and the user equipment, UE, and transmit, to the secondary node, SN, time divisional multiplexing, TDM, assistance information comprising at least one time divisional multiplexing, TDM, pattern for uplink and/or downlink communications between the master node, MN, and/or the secondary node, SN, and the user equipment, UE.

The master node can receive, from the secondary node, SN, data representing a time divisional multiplexing, TDM, pattern of the secondary node, SN, the time divisional multiplexing, TDM, pattern of the secondary node, SN, configured by the secondary node, SN, on the basis of the at least one time divisional multiplexing, TDM, pattern received as part of time divisional multiplexing, TDM, assistance information for uplink and/or downlink communications between the master node, MN, and/or the secondary node, SN, and the user equipment, UE, and transmit, to the user equipment, UE, the data representing the time divisional multiplexing, TDM, pattern of the secondary node, SN. The master node can transmit, to the secondary node, SN, a time divisional multiplexing, TDM, pattern for a master cell group, MCG. The master node can receive, from the secondary node, SN, data representing a time divisional multiplexing, TDM, pattern of the secondary node, SN, the time divisional multiplexing, TDM, pattern of the secondary node, SN, configured by the secondary node, SN, on the basis of the at least one time divisional multiplexing, TDM, pattern received as part of time divisional multiplexing, TDM, assistance information for uplink and/or downlink communications between the master node, MN, and/or the secondary node, SN, and the user equipment, UE, and the time divisional multiplexing, TDM, pattern for the master cell group, MCG, and transmit, to the user equipment, UE, the data representing the time divisional multiplexing, TDM, pattern of the secondary node, SN.

In an example, the master node receive, from the secondary node, SN, data representing a time divisional multiplexing, TDM, pattern of the secondary node, SN, the time divisional multiplexing, TDM, pattern of the secondary node, SN, configured by the secondary node, SN, on the basis of the at least one time divisional multiplexing, TDM, pattern received as part of time divisional multiplexing, TDM, assistance information for uplink and/or downlink communications between the master node, MN, and/or the secondary node, SN, and the user equipment, UE, and configure a time divisional multiplexing, TDM, pattern for a master cell group, MCG on the basis of the time divisional multiplexing, TDM, pattern of the secondary node, SN.

A second aspect of the present disclosure provides a user equipment, UE, configured to operate in dual connectivity, DC, with a master node, MN, and a secondary node, SN, of a telecommunications network such that the user equipment, UE, can transmit and receive data using multiple component carriers of the master node, MN, and the secondary node, SN, wherein the user equipment, UE, is configured to receive, from the master node, MN, a first set of data representing a first set of candidate carrier frequencies and/or a first candidate serving frequency range list for uplink and/or downlink communications between the user equipment, UE and the master node, MN, receive, from the secondary node, SN, a second set of data representing a second set of candidate carrier frequencies and/or a second candidate serving frequency range list for uplink and/or downlink communications between the user equipment, UE and the secondary node, SN and detect in-device coexistence, IDC, on the basis of the first set of data and/or the second set of data, and transmit data to the master node, MN, or to the secondary node, SN, representing an indication of the in-device coexistence, IDC.

In an implementation of the second aspect, the UE can receive, from the master node, MN, data representing an indication for the user equipment, UE, to report, to the master node, MN, a combination of candidate serving frequencies or frequency ranges for uplink and/or downlink communications between the user equipment, UE and the master node, MN and the secondary node, SN, resulting in in-device coexistence, IDC. The UE can receive, from the master node, MN, data representing an indication for the user equipment, UE, to report, to the secondary node, SN, a combination of candidate serving frequencies or frequency ranges for uplink and/or downlink communications between the user equipment, UE and the master node, MN and the secondary node, SN, resulting in in-device coexistence, IDC.

A third aspect of the present disclosure provides a secondary node, SN, in a telecommunication network, wherein the telecommunication network further comprises a master node, MN and a user equipment, UE, and wherein the user equipment, UE, is operable in dual connectivity, DC, with the master node, MN, and with the secondary node, SN, such that the user equipment, UE, can transmit and receive data on multiple carriers of the master node, MN, and the secondary node, SN, the secondary node, SN, being configured to receive, from the master node, MN, data representing a list comprising a set of carrier frequencies and/or frequency ranges affected by in-device coexistence or a combination of candidate serving frequencies or frequency ranges, IDC, for uplink and/or downlink communications between the master node, MN, and/or the secondary node, SN, and the user equipment, UE, wherein the carrier frequencies and/or frequency ranges affected by in-device coexistence, IDC, for uplink and/or downlink communications between the master node, MN, and/or the secondary node, SN, and the user equipment, UE is configured by the secondary node, SN and transmit, to the master node, MN, an acknowledgement message to confirm receipt of the data representing a list comprising a set of carrier frequencies and/or frequency ranges affected by in-device coexistence, IDC.

In an implementation of the third aspect, the secondary node can deactivate a Secondary Cell, SCell, of the telecommunications network; and/or, switch to a different carrier bandwidth part, BWP, from a set of multiple available carrier bandwidth parts, BWPs, for uplink and/or downlink communications between the secondary node, SN, and the user equipment, UE; and/or restrict a physical resource block, PRB, allocation in an unaffected frequency range, whereby to resolve the in-device coexistence, IDC, for uplink and/or downlink communications between the master node, MN, and/or the secondary node, SN, and the user equipment, UE. The secondary node can transmit, the master node, MN, a time divisional multiplexing, TDM, pattern for a secondary cell group, SCG.

These and other aspects of the invention will be apparent from the embodiment(s) described below.

### BRIEF DESCRIPTION OF THE DRAWINGS

In order that the present disclosure may be more readily understood, embodiments will now be described, by way of example, with reference to the accompanying drawings, in which:

FIG. 1 is a schematic representation of in-device coexistence in user equipment comprising transceivers for multiple diverse radio frequency techniques, including WiFi, Bluetooth, New Radio and Global Positioning System;

FIG. 2 is a communication flow according to an example between a UE, an MN and an SN in a MR-DC scheme where the MN generates an FDM configuration when individual candidate frequencies are affected by IDC;

FIG. 3 is a communication flow according to an example between a UE, an MN and an SN in a MR-DC scheme where the MN generates an FDM configuration when a combination of frequencies are affected by IDC;

FIG. 4 is a communication flow according to an example between a UE, an MN and an SN in a MR-DC scheme where the MN generates a TDM configuration when individual frequencies are affected by IDC;

FIG. 5 is a communication flow according to an example between a UE, an MN and an SN in a MR-DC scheme where the MN generates a TDM configuration when a combination of frequencies are affected by IDC;

FIG. 6 is a communication flow according to an example between a UE, an MN and an SN in a MR-DC scheme where the SN generates a TDM configuration when a combination of frequencies are affected by IDC;

FIG. 7 is a communication flow according to an example between a UE, an MN and an SN in a MR-DC scheme where the MN uses a resource coordination procedure when a combination of frequencies are affected by IDC;

FIG. 8 is a communication flow according to an example between a UE, an MN and an SN in a MR-DC scheme where the MN and the SN can configure the UE for FDM when a set of individual frequencies are affected by IDC;

FIG. 9 is a communication flow according to an example between a UE, an MN and an SN in a MR-DC scheme where the MN and the SN can configure the UE for FDM when a combination of frequencies are affected by IDC;

FIG. 10 is a communication flow according to an example between a UE, an MN and an SN in a MR-DC scheme where the MN and the SN can configure the UE for FDM when a combination of frequencies are affected by IDC;

FIG. 11 is a communication flow according to an example between a UE, an MN and an SN in a MR-DC scheme where the MN and the SN can configure the UE for FDM when a combination of frequencies are affected by IDC;

FIG. 12 is a combined communication flow according to an example between a UE, an MN and an SN in a MR-DC scheme where the MN and the SN can configure the UE for FDM when a set of individual frequencies or a combination of frequencies are affected by IDC;

FIG. 13 is a combined communication flow according to an example between a UE, an MN and an SN in a MR-DC scheme where the MN and the SN can configure the UE for FDM when a set of individual frequencies or a combination of frequencies are affected by IDC and the UE reports individual frequencies components from the combinations to either MN or SN; and

FIG. 14 is a schematic representation of a machine according to an example.

FIG. 15 is a combined communication flow according to an example between a UE, an MN and an SN in a MR-DC scheme where the MN and the SN can configure the UE for FDM and TDM when a set of individual frequencies or a combination of frequencies are affected by IDC and MN and SN apply TDM solution to resolve the IDC issue; and

FIG. 16 is a generalized communication flow according to an example between a UE, an MN and an SN in a MR-DC scheme where the MN and the SN can configure the UE for FDM and TDM when a set of individual frequencies or a combination of frequencies are affected by IDC and MN and SN apply Enhanced FDM or TDM solution to resolve the IDC issue.

### DETAILED DESCRIPTION OF ILLUSTRATIVE EMBODIMENTS

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

The phrases “in one implementation,” or “in some implementations,” may each refer to one or more of the same or different implementations. The term “coupled” is defined as connected whether directly or indirectly through intervening components and is not necessarily limited to physical connections. The expression “at least one of A, B and C” or “at least one of the following: A, B and C” means “only A, or only B, or only C, or any combination of A, B and C.”

The terms “system” and “network” may be used interchangeably.

For the purposes of explanation and non-limitation, specific details such as functional entities, techniques, protocols, and standards are set forth for providing an understanding of the present disclosure. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software or a combination of software and hardware. Disclosed functions may correspond to modules which may be software, hardware, firmware, or any combination thereof.

A software implementation may include machine-and/or computer-readable and/or executable instructions stored on a machine-and/or computer-readable medium such as memory or other types of storage devices. One or more microprocessors or general-purpose computers with communication processing capability may be programmed with corresponding executable instructions and perform the disclosed network function(s) or algorithm(s).

The microprocessors or general-purpose computers may include Applications Specific Integrated Circuitry (ASIC), programmable logic arrays, and/or using one or more Digital Signal Processor (DSPs). Although some of the disclosed implementations are oriented to software installed and executing on computer hardware, alternative implementations implemented as firmware or as hardware or as a combination of hardware and software are well within the scope of the present disclosure. The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one user equipment (UE), and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include but is not limited to a mobile station, a mobile terminal or device, or a user communication radio terminal. The UE may be a portable radio equipment that includes but is not limited to a mobile phone, a tablet, a wearable device, a sensor, a vehicle, or a Personal Digital Assistant (PDA) with wireless communication capability. The UE is configured to receive and transmit signals using one or more signaling radio bearers over an air interface to one or more cells in a RAN using one or more of multiple component carriers.

A BS can provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

A BS may include but is not limited to a node B (NB) in the UMTS, an evolved node B (eNB) in LTE or LTE-A, a radio network controller (RNC) in UMTS, a BS controller (BSC) in the GSM/GERAN, a next generation (ng)-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. A BS may serve one or more UEs via a radio interface.

A BS can provide radio coverage to a specific geographical area using a plurality of cells forming the RAN. The BS supports the operations of the cells. Each cell is operable to provide services to at least one UE within its radio coverage.

Each cell (often referred to as a serving cell) can provide services to serve one or more UEs within its radio coverage such that each cell schedules the downlink (DL) and optionally uplink (UL) resources to at least one UE within its radio coverage for DL and optionally UL packet transmissions. The BS can communicate with one or more UEs in the radio communication system via the plurality of cells. A cell may allocate sidelink (SL) resources for supporting Proximity Service (ProSe) or Vehicle to Everything (V2X) service. Each cell may have overlapped coverage areas with other cells.

Examples of some terms used in the present disclosure are:

Primary Cell (PCell): A PCell is the master cell group (MCG) cell, operating on the primary frequency, in which a UE either performs the initial connection establishment procedure or initiates the connection re-establishment procedure. A PCell is the special cell (SpCell) of the MCG.

Primary SCG Cell (PSCell): For dual connectivity (DC) operation, PSCell is the secondary cell group (SCG) cell in which the UE performs random access when performing the Reconfiguration with Sync procedure. PSCell is the SpCell of the SCG. In some implementations, the term PSCell may refer to a Primary Secondary Cell. The term “Primary SCG Cell” and the term “Primary Secondary Cell” may be used interchangeably in the present disclosure.

Special Cell (SpCell): For DC operation the term Special Cell (SpCell) refers to the PCell of the MCG or the PSCell of the SCG, otherwise the term Special Cell refers to the PCell.

Secondary Cell (SCell): For a UE configured with carrier aggregation (CA), SCell is a cell providing additional radio resources on top of Special Cell.

Serving Cell: For a UE in RRC_CONNECTED not configured with CA/DC there is only one serving cell comprising the primary cell. For a UE in RRC_CONNECTED configured with CA/DC the term “serving cells” is used to denote the set of cells comprising the Special Cell(s) and all secondary cells.

Master Cell Group (MCG): in MR-DC, MCG is a group of serving cells associated with the Master Node, comprising the SpCell (PCell) and optionally one or more SCells.

Master Node (MN): in MR-DC, a MN or primary node is the radio access node that provides the control plane connection to the core network. It may be a Master eNB (in EN-DC), a Master ng-eNB (in NGEN-DC) or a Master gNB (in NR-DC and NE-DC). In some implementations, a MN or primary node can comprise a source or target node for a UE.

Secondary Cell Group (SCG): in MR-DC, SCG is a group of serving cells associated with the Secondary Node, comprising of the SpCell (PSCell) and optionally one or more SCells.

Secondary Node (SN): in MR-DC, SN is the radio access node, with no control plane connection to the core network, providing additional resources to the UE. It may be an en-gNB (in EN-DC), a Secondary ng-eNB (in NE-DC) or a Secondary gNB (in NR-DC and NGEN-DC). In some implementations, a SN or secondary node can comprise a source or target node for a UE.

Frequency Division Multiplexing (FDM) is a technique of multiplexing involving combining more than one signal over a shared medium. In FDM, signals of different frequencies are combined for concurrent transmission. A total bandwidth can be divided into a set of frequency bands that do not overlap. Each of these bands comprises a carrier of a different signal that is generated and modulated by one of multiple sending devices. Modulated signals can be combined together using a multiplexer (MUX), and the combined signal can be transmitted over a communication channel, enabling multiple independent data streams to be transmitted simultaneously. At a receiving device, individual signals are extracted from the combined signal by demultiplexing (DEMUX)

Time Division Multiplexing (TDM) is a technique of multiplexing, where users utilise an available bandwidth on a time sharing basis. The time domain is divided into several recurrent slots of fixed length, and each signal is allotted a time slot, e.g., on a round-robin basis.

A UE can communicate with a gNB over a range of frequencies using one or more radio access technologies implementing diverse radio techniques. The range of frequencies may comprise frequencies in the radio frequency part of the electromagnetic spectrum, which corresponds to frequencies of approximately 3 Hz to 3,000 GHz. The range of frequencies may comprise frequencies in the 5G spectrum, from approximately 700 MHz to 80 GHz. The one or more diverse radio techniques may each use at least part of this range of frequencies to send signals between the UE and the gNB. The part(s) of the frequency range used by each technique may not be adjacent and/or contiguous frequency ranges, and in some cases may not be the same for each time slot (for example where the technique uses frequency hopping). There may be interference between signals of one or more of the diverse radio techniques implemented by the UE across one or more frequency ranges in the range of frequencies across which the UE is configured to generally operate, leading to in-device interference. The interference may be due to respective signals sent or received using two of more of the diverse radio techniques implemented by the user device, or may be due to interference between different frequencies for a single technique, such as different frequencies used by 5G NR for example.

As noted above, interference as a result of IDC becomes even more complex when the different frequencies from NR/LTE/WiFi/Bluetooth are inter-modulated. For example, signals from a NR transmitter operating on FR1 (e.g., band n41) can interfere with the signals from a WiFi receiver operating on 2.5G and vice-versa.

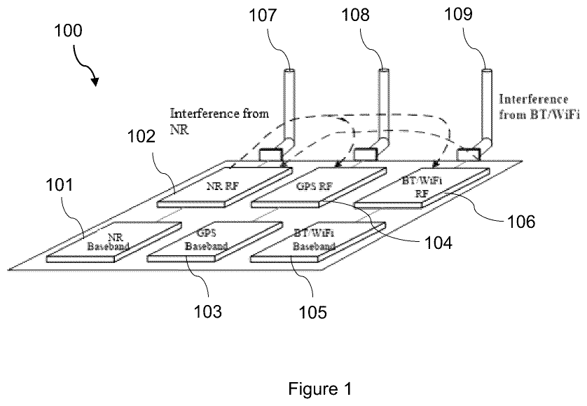

FIG. 1 is a schematic representation of several radio chains for use in a user equipment (UE) according to an example. In the example of FIG. 1, UE 100 accommodates transceivers 101-106 for multiple RATs implementing diverse radio techniques. For example, transceivers 101 and 102 transmit and receive signals for NR using antenna 107, transceivers 103 and 104 transmit and receive signals for GPS using antenna 108, and transceivers 105 and 106 transmit and receive signals for WiFi and Bluetooth using antenna 109. For some frequency bands, concurrent operations of these multiple diverse radio techniques working in adjacent or sub-harmonic frequencies can result in significant IDC interference that cannot be eliminated by filtering. Therefore, signaling mechanisms and procedures have been introduced to address this IDC issue.

According to an example, mechanisms are provided in order to enable a network apparatus, such as a network node, particularly a Master Node (MN) or a Secondary Node (SN), to determine whether co-ordination is needed between the two network nodes (MN and SN) when involved in a dual connectivity procedure, whereby to resolve an IDC issue. Coordination can comprise determining a configuration for resolving an IDC issue, such as by using an FDM or a TDM solution. Accordingly, in the present context, resolution of an IDC issue comprises using a configuration for TDM, or frequency division multiplexing, FDM, whereby to mitigate the effects of the in-device coexistence, IDC, for uplink and/or downlink communications between a master node, MN, and/or a secondary node, SN, and a user equipment, UE.

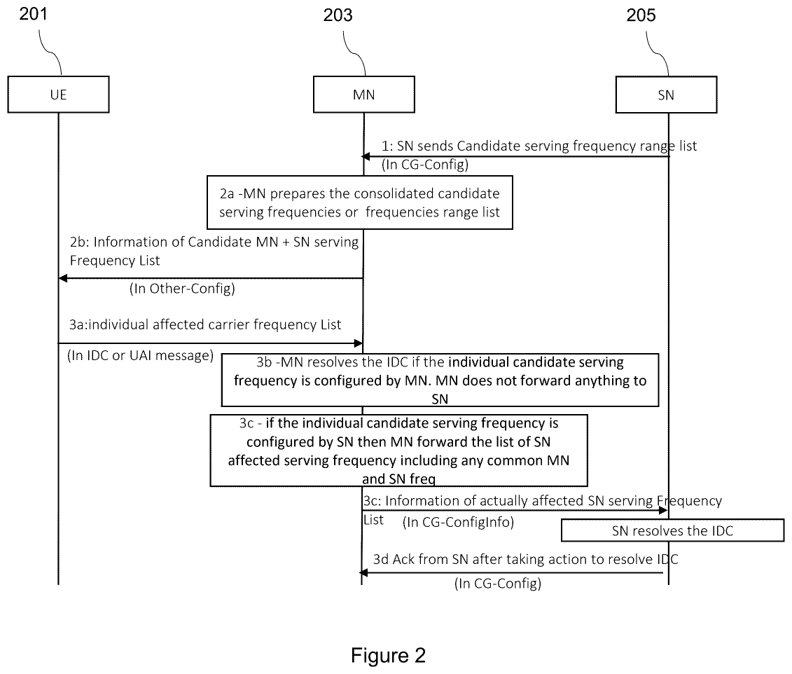

FIG. 2 is a communication flow according to an example between a UE, an MN and an SN in a MR-DC scheme where the MN generates an FDM configuration when individual candidate frequencies are affected by IDC. In the example of FIG. 2, SN 205 sends (1) a Candidate SN serving frequency list (which can include the candidate bandwidth) it is interested in receiving IDC reports in respect of to MN 203 as part of a configuration message (CG-Config). The MN 203 generates (2a) a Combined (or consolidated) Candidate serving frequency range list using a Candidate MN serving frequency list representing a set of candidate frequencies or frequency ranges that the MN is interested in using along with the Candidate SN serving frequency list (which can comprise a frequency range list). The MN 203 transmits (2b) the Combined Candidate serving frequency range list to the UE 201 as part of a configuration message.

The UE 201 now has a Combined Candidate serving frequency range list that a set of carrier frequencies and/or a set of carrier frequency ranges or a combination of candidate serving frequencies/frequency ranges of the MN and SN. The UE 201 uses this to determine whether any of the frequencies will cause an IDC issue. That is, whether use of any of the set of carrier frequencies and/or a set of carrier frequency ranges or a combination of candidate serving frequencies/frequency ranges of the MN and/or SN will cause in-device interference between UE transceivers as a result of their physical proximity, spectral closeness, and/or imperfect radio frequency (RF) filtering. If the UE 201 detects such an issue, representing an IDC problem, the UE 201 can report (3a) this to the MN 203 as part of an IDC message (for EN-DC) or a UE assistance information (UAI) message (for NR-DC). In an example, the information reported by the UE 201 as part of an IDC message (for EN-DC) or a UE assistance information (UAI) message (for NR-DC) can comprise data representing an indication of a set of carrier frequencies and/or a set of carrier frequency ranges or a combination of candidate serving frequencies/frequency ranges of the master node, MN, and/or of the secondary node, SN, affected by in-device coexistence, IDC, for uplink and/or downlink communications between the master node, MN, and/or the secondary node, SN, and the user equipment, UE.

According to an example, if the individual candidate serving frequency is configured by the MN 203, the MN 203 can take action (3b) to resolve the IDC problem. For example, the MN 203 can apply scheduling restrictions on current or future serving frequencies. In this case, no information is provided to the SN 205 by the MN 203.

If the individual candidate serving frequency is configured by the SN 205 (including any common MN and SN frequencies for example) the MN 203 can transmit (3c) the data comprising a list of affected serving frequency (e.g., a frequency that is configured by the SN 205 and included in the set of affected carrier frequencies reported by the UE 201 in the IDC or UAI message) to the SN 205 as part of a configuration message. The SN 205 can take action to resolve the IDC problem. In an example, there can also be an explicit indication that any IDC problem is due to an individual SN frequency. An acknowledge message can be transmitted (3d) from the SN 205 to the MN 203 once action has been taken by the SN 205 to resolve the IDC issue. In an example, in general, an action to resolve an IDC issue by the SN 205 can comprise deactivating a Secondary Cell, SCell, of the telecommunications network; and/or, switching to a different carrier bandwidth part, BWP, from a set of multiple available carrier bandwidth parts, BWPs, for uplink and/or downlink communications between the secondary node, SN, and the user equipment, UE; and/or restricting a physical resource block, PRB, allocation in an unaffected frequency range, whereby to resolve the in-device coexistence, IDC, for uplink and/or downlink communications between the master node, MN, and/or the secondary node, SN, and the user equipment, UE. In an example, in general, an action to resolve an IDC issue by the MN 203 can comprise deactivating a Secondary Cell, SCell, of the telecommunications network; and/or, switching to a different carrier bandwidth part, BWP, from a set of multiple available carrier bandwidth parts, BWPs, for uplink and/or downlink communications between the master node, MN, and the user equipment, UE; and/or restricting a physical resource block, PRB, allocation in an unaffected frequency range, whereby to resolve the in-device coexistence, IDC, for uplink and/or downlink communications between the master node, MN, and/or the secondary node, SN, and the user equipment, UE.

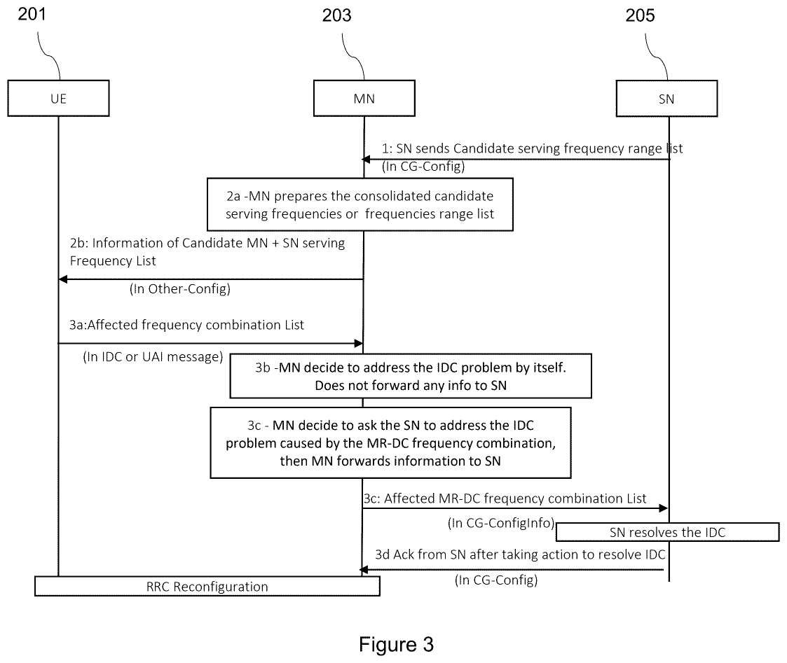

FIG. 3 is a communication flow according to an example between a UE, an MN and an SN in a MR-DC scheme where the MN generates an FDM configuration when a combination of frequencies are affected by IDC. In the example of FIG. 3 SN 205 transmits (1) a Candidate SN serving frequency or frequency ranges list (which can include the candidate bandwidth) it is interested in receiving IDC reports in respect of to MN 203 as part of a configuration message (CG-Config). The MN 203 generates (2a) a Combined (or consolidated) Candidate serving frequency range list using a Candidate MN serving frequency list representing a set of candidate frequencies or frequency ranges that the MN is interested in using along with the Candidate SN serving frequency list (which can comprise a frequency range list). The MN 203 transmits (2b) the Combined Candidate serving frequency range list to the UE 201 as part of a configuration message.

The UE 201 now has a Combined Candidate serving frequency range list that a set of carrier frequencies and/or a set of carrier frequency ranges or a combination of candidate serving frequencies/frequency ranges of the MN and SN. The UE 201 uses this to determine whether any of the frequencies will cause an IDC issue. That is, whether use of any of the set of carrier frequencies and/or a set of carrier frequency ranges or a combination of candidate serving frequencies/frequency ranges of the MN and/or SN will cause in-device interference between UE transceivers as a result of their physical proximity, spectral closeness, and/or imperfect radio frequency (RF) filtering. If the UE 201 detects such an issue, representing an IDC problem, the UE 201 can report (3a) this to the MN 203 as part of an IDC message (for EN-DC) or a UE assistance information (UAI) message (for NR-DC). In an example, the information reported by the UE 201 as part of an IDC message (for EN-DC) or a UE assistance information (UAI) message (for NR-DC) can comprise data representing an indication of a set of carrier frequencies and/or a set of carrier frequency ranges or a combination of candidate serving frequencies/frequency ranges of the master node, MN, and/or of the secondary node, SN, affected by in-device coexistence, IDC, for uplink and/or downlink communications between the master node, MN, and/or the secondary node, SN, and the user equipment, UE.

According to an example, if the individual candidate serving frequency range is configured by the MN 203, the MN 203 can take action (3b) to resolve the IDC problem. For example, the MN 203 can apply scheduling restrictions on current or future serving frequency ranges. In this case, no information is provided to the SN 205 by the MN 203.

If the individual candidate serving frequency range is configured by the SN 205 (including any common MN and SN frequency ranges for example) the MN 203 can transmit (3c) the data comprising a list of affected serving frequency ranges (e.g., a frequency range that is configured by the SN 205 and included in the set of affected carrier frequency ranges reported by the UE 201 in the IDC or UAI message) to the SN 205 as part of a configuration message. The SN 205 can take action to resolve the IDC problem. In an example, there can also be an explicit indication that any IDC problem is due to an individual SN frequency. An acknowledge message can be transmitted (3d) from the SN 205 to the MN 203 once action has been taken by the SN 205 to resolve the IDC issue. In an example, in general, an action to resolve an IDC issue by the SN 205 can comprise implementing an FDM solution by, e.g., deactivating a Secondary Cell, SCell, of the telecommunications network; and/or, switching to a different carrier bandwidth part, BWP, from a set of multiple available carrier bandwidth parts, BWPs, for uplink and/or downlink communications between the secondary node, SN, and the user equipment, UE; and/or restricting a physical resource block, PRB, allocation in an unaffected frequency range, whereby to resolve the in-device coexistence, IDC, for uplink and/or downlink communications between the master node, MN, and/or the secondary node, SN, and the user equipment, UE. In an example, in general, an action to resolve an IDC issue by the MN 203 can comprise implementing an FDM solution by, e.g., deactivating a Secondary Cell, SCell, of the telecommunications network; and/or, switching to a different carrier bandwidth part, BWP, from a set of multiple available carrier bandwidth parts, BWPs, for uplink and/or downlink communications between the master node, MN, and the user equipment, UE; and/or restricting a physical resource block, PRB, allocation in an unaffected frequency range, whereby to resolve the in-device coexistence, IDC, for uplink and/or downlink communications between the master node, MN, and/or the secondary node, SN, and the user equipment, UE. In an example, there can be an explicit indication that an IDC problem is due to a combination of frequencies and only an SN 205 frequency from such a combination is transmitted to the SN 205.

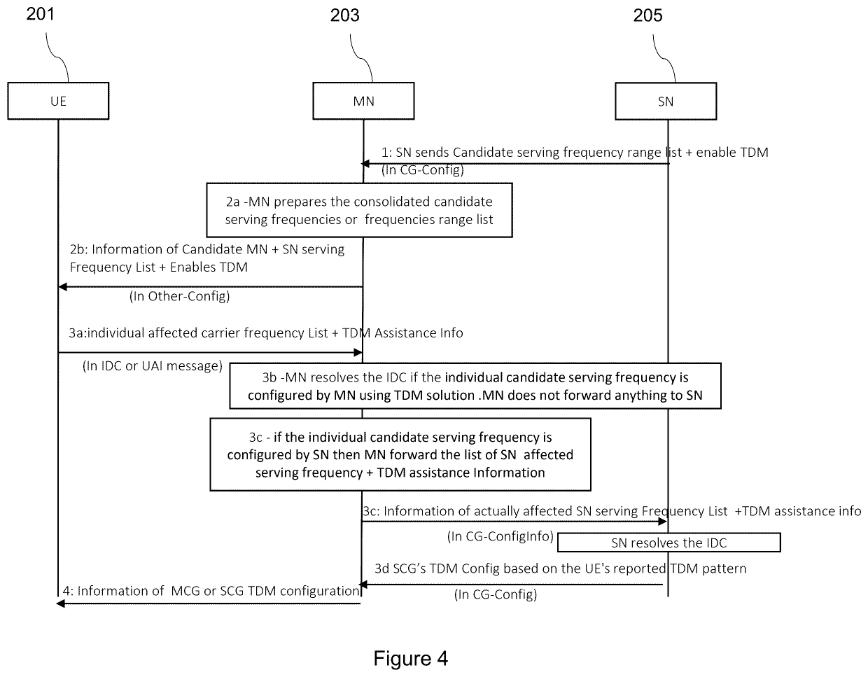

FIG. 4 is a communication flow according to an example between a UE, an MN and an SN in a MR-DC scheme where the MN generates a TDM configuration when individual frequencies are affected by IDC. In the example of FIG. 4 SN 205 transmits (1) a Candidate SN serving frequency or frequency ranges list (which can include the candidate bandwidth) it is interested in receiving IDC reports in respect of to MN 203 as part of a configuration message (CG-Config). As part of this message the SN 205 can include an indication to the MN 203 to enable the use of TDM for uplink and/or downlink communications between the master node, MN, and/or the secondary node, SN, and the user equipment, UE.

The MN 203 generates (2a) a Combined (or consolidated) Candidate serving

frequency range list using a Candidate MN serving frequency list representing a set of candidate frequencies or frequency ranges that the MN is interested in using along with the Candidate SN serving frequency list (which can comprise a frequency range list). The MN 203 transmits (2b) the Combined Candidate serving frequency range list to the UE 201 as part of a configuration message, which also includes an indication that TDM is enabled for uplink and/or downlink communications between the master node, MN, and/or the secondary node, SN, and the user equipment, UE.

The UE 201 now has a Combined Candidate serving frequency range list that a set of carrier frequencies and/or a set of carrier frequency ranges or a combination of candidate serving frequencies/frequency ranges of the MN and SN. The UE 201 uses this to determine whether any of the frequencies will cause an IDC issue. That is, whether use of any of the set of carrier frequencies and/or a set of carrier frequency ranges or a combination of candidate serving frequencies/frequency ranges of the MN and/or SN will cause in-device interference between UE transceivers as a result of their physical proximity, spectral closeness, and/or imperfect radio frequency (RF) filtering. If the UE 201 detects such an issue, representing an IDC problem, the UE 201 can report (3a) this to the MN 203 as part of an IDC message (for EN-DC) or a UE assistance information (UAI) message (for NR-DC) that can include TDM assistance information for the UE 201 in which the UE 201 can inform the MN 203 of an internal status of the UE 201 so that resources can be appropriately assigned. For example, one or more UE configuration parameters can be provided comprising at least one preferred parameter for a UE 201 TDM configuration.

In an example, the information reported by the UE 201 as part of an IDC message (for EN-DC) or a UE assistance information (UAI) message (for NR-DC) can comprise data representing an indication of a set of carrier frequencies and/or a set of carrier frequency ranges or a combination of candidate serving frequencies/frequency ranges of the master node, MN, and/or of the secondary node, SN, affected by in-device coexistence, IDC, for uplink and/or downlink communications between the master node, MN, and/or the secondary node, SN, and the user equipment, UE.

According to an example, if the individual candidate serving frequency or frequencies are configured by the MN 205, then the MN can take action (3b) to resolve the IDC problem (e.g., by generating a configuration for a TDM pattern). Nothing is forwarded to SN.

If the individual candidate serving frequency or frequencies are configured by the SN 205 then the MN 203 can transmit (3c) the list of such an affected serving frequency or frequencies (i.e., a frequency or frequencies configured by the SN 205 and included in the affected carrier frequency reported by UE 101 in IDC or UAI message) along with TDM assistance information to the SN 205. The SN 205 can then take action to resolve the IDC problem by using a configuration for TDM, whereby to mitigate the effects of the in-device coexistence, IDC, for uplink and/or downlink communications between the master node, MN, and/or the secondary node, SN, and the user equipment, UE.

The SN 205 can transmit (3d) an SCG TDM configuration to the MN 203, wherein the SCG TDM configuration is generated on the basis of the UE's reported TDM pattern. The MN can transmit (4) information representing an MCG or SCG TDM configuration to the UE 201.

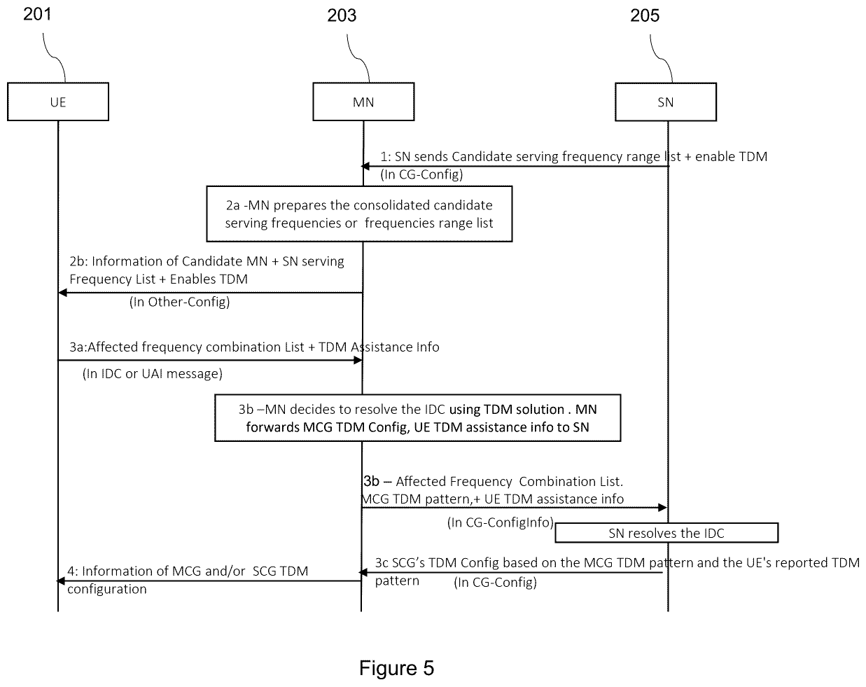

FIG. 5 is a communication flow according to an example between a UE, an MN and an SN in a MR-DC scheme where the MN generates a TDM configuration when a combination of frequencies are affected by IDC. In the example of FIG. 5 SN 205 transmits (1) a Candidate SN serving frequency range list (which can include the candidate bandwidth) it is interested in receiving IDC reports in respect of to MN 203 as part of a configuration message (CG-Config). As part of this message the SN 205 can include an indication to the MN 203 to enable the use of TDM for uplink and/or downlink communications between the MN 203 and/or the SN 205 and UE 101.

The MN 203 generates (2a) a Combined (or consolidated) Candidate serving frequency range list using a Candidate MN serving frequency range list representing a set of candidate frequencies or frequency ranges that the MN is interested in using along with the Candidate SN serving frequency range list. The MN 203 transmits (2b) the Combined Candidate serving frequency range list to the UE 201 as part of a configuration message, which also includes an indication that TDM is enabled for uplink and/or downlink communications between the MN 203 and/or the SN 205 and UE 101.

The UE 201 now has a Combined Candidate serving frequency range list that a set of carrier frequencies and/or a set of carrier frequency ranges or a combination of candidate serving frequencies/frequency ranges of the MN and SN. The UE 201 uses this to determine whether any of the frequencies or frequency ranges will cause an IDC issue. That is, whether use of any of the set of carrier frequencies and/or a set of carrier frequency ranges or a combination of candidate serving frequencies/frequency ranges of the MN and/or SN will cause in-device interference between UE transceivers as a result of their physical proximity, spectral closeness, and/or imperfect radio frequency (RF) filtering. If the UE 201 detects such an issue, representing an IDC problem, the UE 201 can report (3a) this to the MN 203 as part of an IDC message (for EN-DC) or a UE assistance information (UAI) message (for NR-DC) that can include TDM assistance information for the UE 201 in which the UE 201 can inform the MN 203 of an internal status of the UE 201 so that resources can be appropriately assigned. For example, one or more UE configuration parameters can be provided comprising at least one preferred parameter for a UE 201 TDM configuration.

In an example, the information reported by the UE 201 as part of an IDC message (for EN-DC) or a UE assistance information (UAI) message (for NR-DC) can comprise data representing an indication of a set of carrier frequencies and/or a set of carrier frequency ranges or a combination of candidate serving frequencies/frequency ranges of the MN 203 and/or of the SN 205 affected by in-device coexistence, IDC, for uplink and/or downlink communications between the MN 203 and/or the SN 205 and UE 101.

According to an example, if the individual candidate serving frequency range is configured by the MN 205, then the MN can take action (3b) to resolve the IDC problem (e.g., by generating a configuration for a TDM pattern). MN 203 transits (3b) data representing the list of affected frequency ranges, a configuration representing an MCG TDM pattern and the UE assistance information to the SN 205. The SN 205 can use this data to generate a configuration representing an SCG TDM pattern that is based on the MCG TDM pattern and a UE's reported TDM pattern from the UE assistance information. The generated SCG TDM pattern is transmitted (3c) to the MN 203. Information representing the MCG and/or SCG TDM pattern can be transmitted (4) to the UE 101 from the MN 203 in order to thereby resolve the IDC issue. That is, the configurations implemented by the UE, MN and/or SN using the generated TDM pattern(s) can mitigate the effects of any in-device interference at the UE 101.

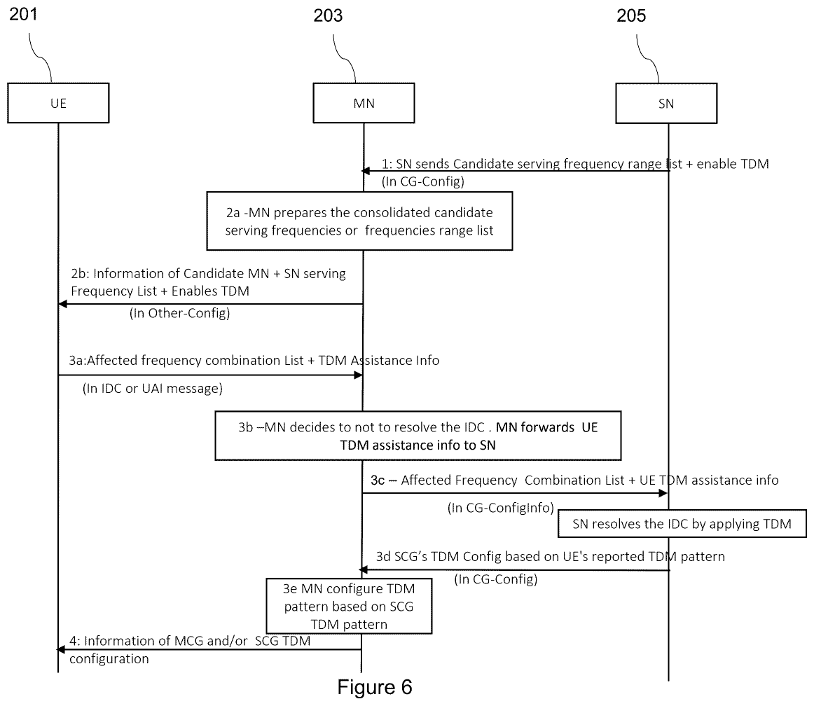

FIG. 6 is a communication flow according to an example between a UE, an MN and an SN in a MR-DC scheme where the SN generates a TDM configuration when a combination of frequencies are affected by IDC. In the example of FIG. 6 SN 205 transmits (1) a Candidate SN serving frequency range list (which can include the candidate bandwidth) it is interested in receiving IDC reports in respect of to MN 203 as part of a configuration message (CG-Config). As part of this message the SN 205 can include an indication to the MN 203 to enable the use of TDM for uplink and/or downlink communications between the MN 203 and/or the SN 205 and UE 101.

The MN 203 generates (2a) a Combined (or consolidated) Candidate serving frequencies or frequency range list using a Candidate MN serving frequency range list representing a set of candidate frequencies or frequency ranges that the MN is interested in using along with the Candidate SN serving frequency range list. The MN 203 transmits (2b) the Combined Candidate serving frequency range list to the UE 201 as part of a configuration message, which also includes an indication that TDM is enabled for uplink and/or downlink communications between the MN 203 and/or the SN 205 and UE 101.

The UE 201 now has a Combined Candidate serving frequency range list that a set of carrier frequencies and/or a set of carrier frequency ranges or a combination of candidate serving frequencies/frequency ranges of the MN and SN. The UE 201 uses this to determine whether any of the frequencies or frequency ranges will cause an IDC issue. That is, whether use of any of the set of carrier frequencies and/or a set of carrier frequency ranges or a combination of candidate serving frequencies/frequency ranges of the MN and/or SN will cause in-device interference between UE transceivers as a result of their physical proximity, spectral closeness, and/or imperfect radio frequency (RF) filtering. If the UE 201 detects such an issue, representing an IDC problem, the UE 201 can report (3a) this to the MN 203 as part of an IDC message (for EN-DC) or a UE assistance information (UAI) message (for NR-DC) that can include TDM assistance information for the UE 201 in which the UE 201 can inform the MN 203 of an internal status of the UE 201 so that resources can be appropriately assigned. For example, one or more UE configuration parameters can be provided comprising at least one preferred parameter for a UE 201 TDM configuration.

In an example, the information reported by the UE 201 as part of an IDC message (for EN-DC) or a UE assistance information (UAI) message (for NR-DC) can comprise data representing an indication of a set of carrier frequencies and/or a set of carrier frequency ranges or a combination of candidate serving frequencies/frequency ranges of the MN 203 and/or of the SN 205 affected by in-device coexistence, IDC, for uplink and/or downlink communications between the MN 203 and/or the SN 205 and UE 101.

According to an example, the MN 203 can be configured to forward the UE 101 TDM assistance information to the SN 205. That is, MN 203 does not (3b) take active measures to resolve an IDC issue reported by the UE 101. Accordingly, MN 203 can transmit (3c) data representing the list of affected frequencies and the UE assistance information to the SN 205. The SN 205 can use this information to resolve the IDC issue by generating a configuration for a TDM pattern to be used. In an example, SN 205 generates a configuration representing an SCG TDM pattern on the basis of the UEs reported TDM pattern (provided as part of the UE assistance information for example) and forwards (3d) this to the MN 203. MN 203 generates (3e) a configuration representing an MCG TDM pattern based on the received SCG pattern information and the UEs reported TDM pattern. The MN 203 can transmit (4) information representing the MCG and SCG TDM configurations to the UE 101, thereby enabling resolution of the IDC problem.

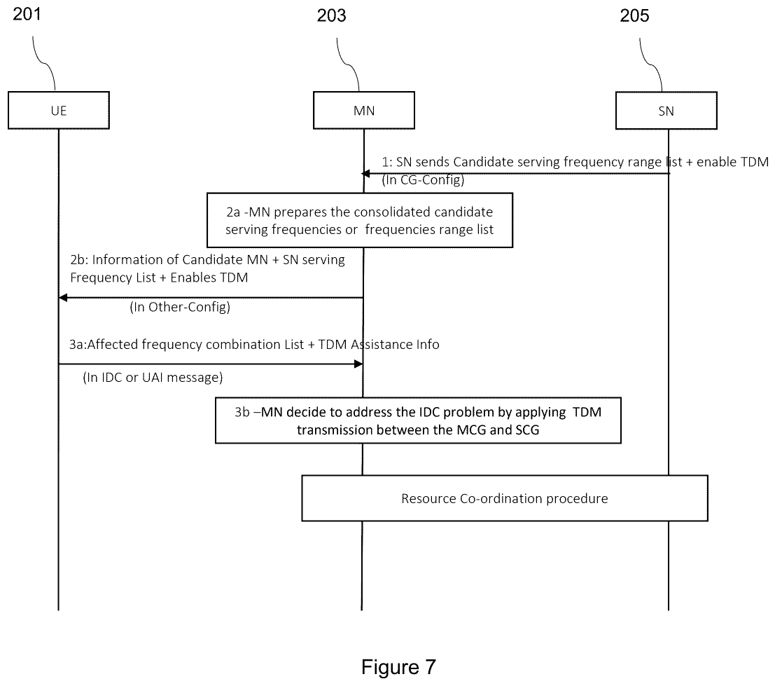

FIG. 7 is a communication flow according to an example between a UE, an MN and an SN in a MR-DC scheme where the MN uses a resource coordination procedure when a combination of frequencies are affected by IDC. In the example of FIG. 7 SN 205 transmits (1) a Candidate SN serving frequency range list (which can include the candidate bandwidth) it is interested in receiving IDC reports in respect of to MN 203 as part of a configuration message (CG-Config). As part of this message the SN 205 can include an indication to the MN 203 to enable the use of TDM for uplink and/or downlink communications between the MN 203 and/or the SN 205 and UE 101.

The MN 203 generates (2a) a Combined (or consolidated) Candidate serving frequencies or frequency range list using a Candidate MN serving frequency range list representing a set of candidate frequencies or frequency ranges that the MN is interested in using along with the Candidate SN serving frequency range list. The MN 203 transmits (2b) the Combined Candidate serving frequency range list to the UE 201 as part of a configuration message, which also includes an indication that TDM is enabled for uplink and/or downlink communications between the MN 203 and/or the SN 205 and UE 101.

The UE 201 now has a Combined Candidate serving frequency range list that a set of carrier frequencies and/or a set of carrier frequency ranges or a combination of candidate serving frequencies/frequency ranges of the MN and SN. The UE 201 uses this to determine whether any of the frequencies or frequency ranges will cause an IDC issue. That is, whether use of any of the set of carrier frequencies and/or a set of carrier frequency ranges or a combination of candidate serving frequencies/frequency ranges of the MN and/or SN will cause in-device interference between UE transceivers as a result of their physical proximity, spectral closeness, and/or imperfect radio frequency (RF) filtering. If the UE 201 detects such an issue, representing an IDC problem, the UE 201 can report (3a) this to the MN 203 as part of an IDC message (for EN-DC) or a UE assistance information (UAI) message (for NR-DC) that can include TDM assistance information for the UE 201 in which the UE 201 can inform the MN 203 of an internal status of the UE 201 so that resources can be appropriately assigned. For example, one or more UE configuration parameters can be provided comprising at least one preferred parameter for a UE 201 TDM configuration.

In an example, the information reported by the UE 201 as part of an IDC message (for EN-DC) or a UE assistance information (UAI) message (for NR-DC) can comprise data representing an indication of a set of carrier frequencies and/or a set of carrier frequency ranges or a combination of candidate serving frequencies/frequency ranges of the MN 203 and/or of the SN 205 affected by in-device coexistence, IDC, for uplink and/or downlink communications between the MN 203 and/or the SN 205 and UE 101.

In the example of FIG. 7, MN 203 can address the IDC issue that has been alerted by the UE 101 by applying/using a configuration representing TDM transmissions between an MCG and an SCG. That is, according to an example, MN 203 can negotiate (3b) an UL TDM pattern with the SN 205 using existing MR-DC Resource Coordination Information or MeNB Resource Coordination Information.

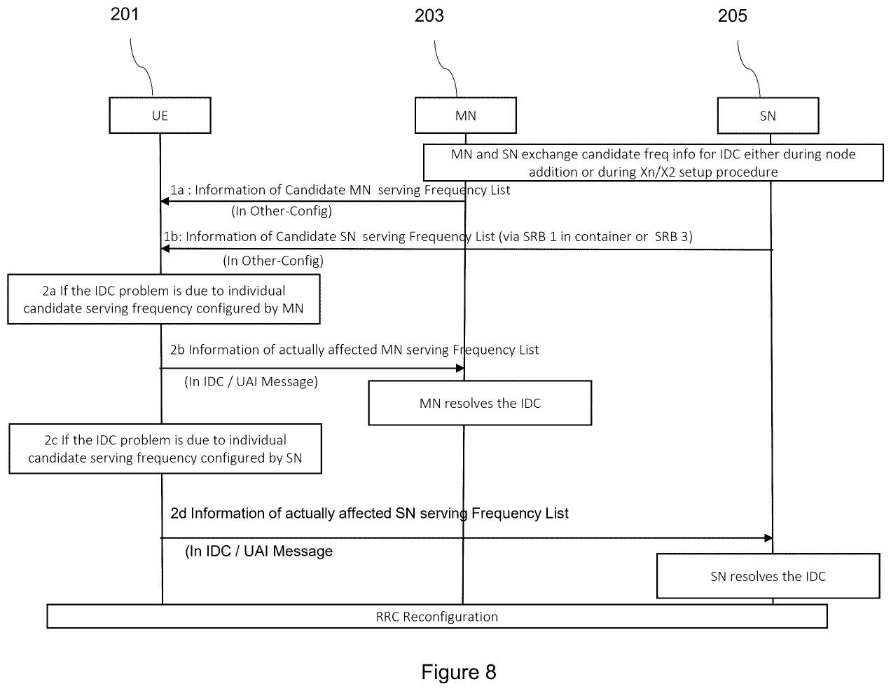

FIG. 8 is a communication flow according to an example between a UE, an MN and an SN in a MR-DC scheme where the MN and the SN can configure the UE for FDM when a set of individual frequencies are affected by IDC. In the example of FIG. 8 MN 203 and SN 205 exchange information representing the candidate frequencies. However, the MN 203 and the SN 205 separately configure IDC configurations (i.e., candidate serving frequencies) for the UE (without any coordination). That is, the MN 203 configures (1a) the Candidate serving frequency range list for UE 101 for IDC reporting to MN 205. The SN 205 configures the Candidate serving frequency range list for IDC Reporting to SN 205 (via a signal radio bearer 1 (SRB 1) container or a signal radio bearer 3 (SRB 3)).

The UE 201 uses the information from the MN 203 and the SN 205 to determine (2a) whether any of the frequencies will cause an IDC issue. That is, whether use of any of the set of carrier frequencies and/or a set of carrier frequency ranges or a combination of candidate serving frequencies/frequency ranges of the MN and/or SN will cause in-device interference between UE transceivers as a result of their physical proximity, spectral closeness, and/or imperfect radio frequency (RF) filtering. If the UE 201 detects such an issue, representing an IDC problem, the UE checks (2a) whether the IDC problem is due to individual candidate serving frequencies configured by the MN 203. The UE 101 can report (2b) such individual affected carrier frequencies in an IDC or UAI message to the MN 205 in order to enable the MN 205 to resolve the IDC issue.

The UE can check (2c) whether the IDC problem is due to individual candidate serving frequencies configured by the SN 205. The UE 101 can report (2d) such individual affected carrier frequencies in an IDC or UAI message to the SN 205 using a container in SRB1 or using SRB 3 in order to enable the SN 205 to resolve the IDC issue. Accordingly, as appropriate, the MN 203 or the SN 205 can resolve the IDC issue as described above for example.

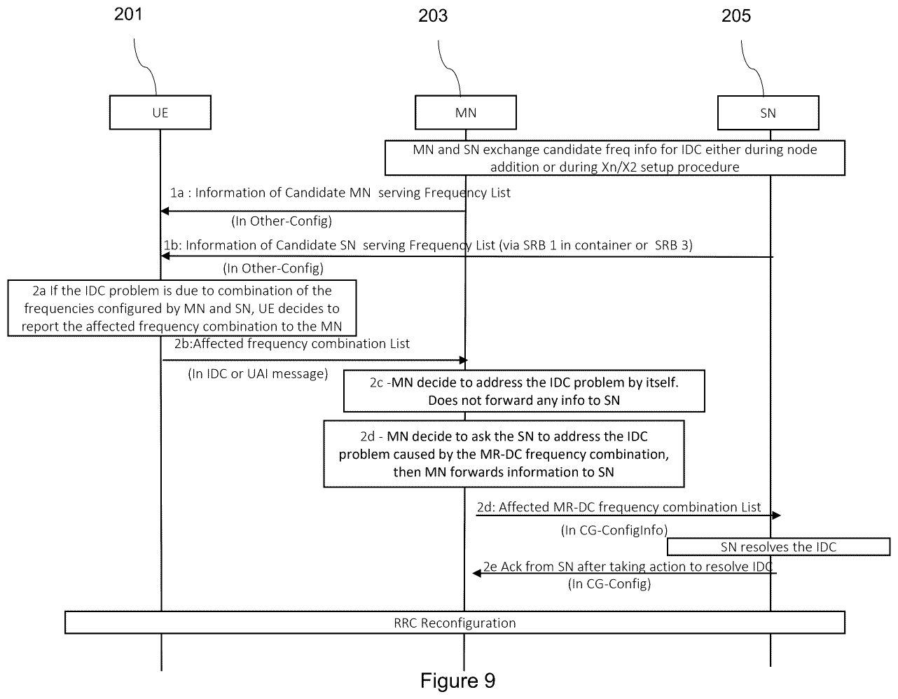

FIG. 9 is a communication flow according to an example between a UE, an MN and an SN in a MR-DC scheme where the MN and the SN can configure the UE for FDM when a combination of frequencies are affected by IDC. In the example of FIG. 9 MN 203 and SN 205 exchange information representing the candidate frequencies. However, the MN 203 and the SN 205 separately configure IDC configurations (i.e., candidate serving frequencies) for the UE (without any coordination). In an example, the MN 203 and the SN 205 can exchange candidate frequency information either during node addition or during an Xn/X2 setup procedure.

The MN 203 configures (1a) the Candidate serving frequency range list for UE 101 for IDC reporting to MN 205. The SN 205 configures the Candidate serving frequency range list for IDC Reporting to SN 205 (via a signal radio bearer 1 (SRB 1) container or a signal radio bearer 3 (SRB 3)).

The UE 201 uses the information from the MN 203 and the SN 205 to determine (2a) whether the combination of frequencies will cause an IDC issue. That is, whether an IDC issue is generated due to the combination of the frequencies configured by the MN 203 and the SN 205. If there is an issue due to the combination of the frequencies configured by the MN 203 and the SN 205, the UE 101 can report (2b) the affected frequency combination to the MN 203 as part of an IDC message (for EN-DC) or a UE assistance information (UAI) message (for NR-DC).

If the MN 203 decide to address the IDC problem by itself e.g., by deactivating a Secondary Cell, SCell, of the telecommunications network; and/or, switching to a different carrier bandwidth part, BWP, from a set of multiple available carrier bandwidth parts, BWPs, for uplink and/or downlink communications between the master node, MN, and the user equipment, UE; and/or restricting a physical resource block, PRB, allocation in an unaffected frequency range, then the MN 203 does not forward any information to the SN 205.

However, if the MN 203 decides to have the SN address the IDC problem caused by the MR-DC frequency combination, the MN 203 can forward (2d) information about the MR-DC frequency combination to the SN 205. This means that there is an implicit indication for the SN 205 to act. The SN 205 can then apply an FDM solution to resolve the IDC issue, such as by deactivating a Secondary Cell, SCell, of the telecommunications network; and/or, switching to a different carrier bandwidth part, BWP, from a set of multiple available carrier bandwidth parts, BWPs, for uplink and/or downlink communications between the SN, and the UE; and/or restricting a physical resource block, PRB, allocation in an unaffected frequency range, whereby to resolve the in-device coexistence, IDC, for uplink and/or downlink communications between the master node, MN, and/or the secondary node, SN, and the user equipment, UE. There can also be an explicit indication that an IDC problem is due to a combination of frequencies and only an SN frequency from the combination is forwarded. The SN 205 can resolve the IDC issue and transmit an acknowledgement (2e) to the MN 203.

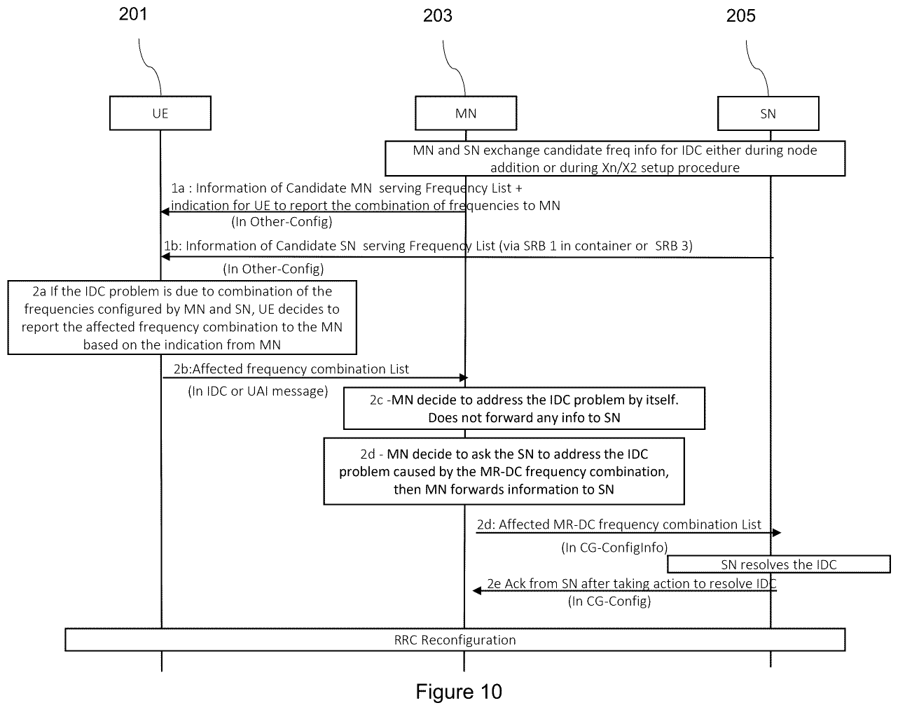

FIG. 10 is a communication flow according to an example between a UE, an MN and an SN in a MR-DC scheme where the MN and the SN can configure the UE for FDM when a combination of frequencies are affected by IDC. In the example of FIG. 10 MN 203 and SN 205 exchange information representing the candidate frequencies. However, the MN 203 and the SN 205 separately configure IDC configurations (i.e., candidate serving frequencies) for the UE (without any coordination). In an example, the MN 203 and the SN 205 can exchange candidate frequency information either during node addition or during an Xn/X2 setup procedure.

The MN 203 configures (1a) the Candidate serving frequency range list for UE 101 for IDC reporting to MN 205. The MN 203 also provides an indication for the UE 101 to report the combination of affected frequencies to the MN 203. The SN 205 configures the Candidate serving frequency range list for IDC Reporting to SN 205 (via a signal radio bearer 1 (SRB 1) container or a signal radio bearer 3 (SRB 3)).

The UE 201 uses the information from the MN 203 and the SN 205 to determine (2a) whether the combination of frequencies will cause an IDC issue. That is, whether an IDC issue is generated due to the combination of the frequencies configured by the MN 203 and the SN 205. If there is an issue due to the combination of the frequencies configured by the MN 203 and the SN 205, the UE 101 can report (2b) the affected frequency combination to the MN 203 as part of an IDC message (for EN-DC) or a UE assistance information (UAI) message (for NR-DC). The entity to report (2b) the affected frequency combination to (i.e., the MN 205 in this example) is determined on the basis on the indication from the MN 203.

If the MN 203 decide to address the IDC problem by itself (2c) e.g., by deactivating a Secondary Cell, SCell, of the telecommunications network; and/or, switching to a different carrier bandwidth part, BWP, from a set of multiple available carrier bandwidth parts, BWPs, for uplink and/or downlink communications between the master node, MN, and the user equipment, UE; and/or restricting a physical resource block, PRB, allocation in an unaffected frequency range, then the MN 203 does not forward any information to the SN 205.

However, if the MN 203 decides to have the SN address the IDC problem caused by the MR-DC frequency combination, the MN 203 can forward (2d) information about the MR-DC frequency combination to the SN 205. This means that there is an implicit indication for the SN 205 to act. The SN 205 can then apply an FDM solution to resolve the IDC issue, such as by deactivating a Secondary Cell, SCell, of the telecommunications network; and/or, switching to a different carrier bandwidth part, BWP, from a set of multiple available carrier bandwidth parts, BWPs, for uplink and/or downlink communications between the SN, and the UE; and/or restricting a physical resource block, PRB, allocation in an unaffected frequency range, whereby to resolve the in-device coexistence, IDC, for uplink and/or downlink communications between the master node, MN, and/or the secondary node, SN, and the user equipment, UE. There can also be an explicit indication that an IDC problem is due to a combination of frequencies and only an SN frequency from the combination is forwarded. The SN 205 can resolve the IDC issue and transmit an acknowledgement (2e) to the MN 203.

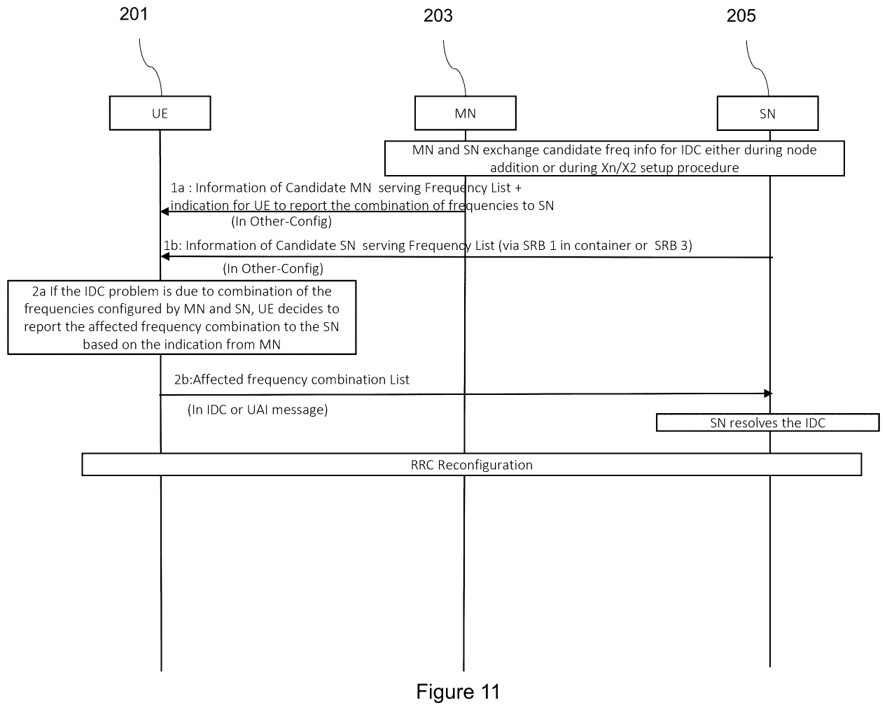

FIG. 11 is a communication flow according to an example between a UE, an MN and an SN in a MR-DC scheme where the MN and the SN can configure the UE for FDM when a combination of frequencies are affected by IDC. In the example of FIG. 11 MN 203 and SN 205 exchange information representing the candidate frequencies. However, the MN 203 and the SN 205 separately configure IDC configurations (i.e., candidate serving frequencies) for the UE (without any coordination). In an example, the MN 203 and the SN 205 can exchange candidate frequency information either during node addition or during an Xn/X2 setup procedure.

The MN 203 configures (1a) the Candidate serving frequency range list for UE 101 for IDC reporting to MN 205 and forwards this to the UE 101. The MN 203 also provides an indication for the UE 101 to report the combination of affected frequencies to the SN 205. The SN 205 configures the Candidate serving frequency range list for IDC Reporting to SN 205 and transmits (1b) this to the UE 101 (via a signal radio bearer 1 (SRB 1) container or a signal radio bearer 3 (SRB 3)).

The UE 201 uses the information from the MN 203 and the SN 205 to determine (2a) whether the combination of frequencies will cause an IDC issue. That is, whether an IDC issue is generated due to the combination of the frequencies configured by the MN 203 and the SN 205. If there is an issue due to the combination of the frequencies configured by the MN 203 and the SN 205, the UE 101 can report (2b) the affected frequency combination to the SN 205 as part of an IDC message (for EN-DC) or a UE assistance information (UAI) message (for NR-DC). The entity to report (2b) the affected frequency combination to (i.e., the SN 205 in this example) is determined on the basis on the indication from the MN 203.

The SN 205 can then apply an FDM solution to resolve the IDC issue, such as by deactivating a Secondary Cell, SCell, of the telecommunications network; and/or, switching to a different carrier bandwidth part, BWP, from a set of multiple available carrier bandwidth parts, BWPs, for uplink and/or downlink communications between the SN, and the UE; and/or restricting a physical resource block, PRB, allocation in an unaffected frequency range, whereby to resolve the in-device coexistence, IDC, for uplink and/or downlink communications between the master node, MN, and/or the secondary node, SN, and the user equipment, UE. There can also be an explicit indication that an IDC problem is due to a combination of frequencies and only an SN frequency from the combination is forwarded. The SN 205 can resolve the IDC issue.

In another example, the MN 203 and SN 205 exchange information representing the candidate frequencies. However, the MN 203 and the SN 205 separately configure IDC configurations (i.e., candidate serving frequencies) for the UE (without any coordination). In an example, the MN 203 and the SN 205 can exchange candidate frequency information either during node addition or during an Xn/X2 setup procedure.

The MN 203 can configures the Candidate serving frequency range list for UE 101 for IDC reporting to MN 205 and forwards this to the UE 101. The SN 205 configures the Candidate serving frequency range list for IDC Reporting to SN 205 and transmits this to the UE 101 (via a signal radio bearer 1 (SRB 1) container or a signal radio bearer 3 (SRB 3)).

The UE 201 uses the information from the MN 203 and the SN 205 to determine whether the combination of frequencies will cause an IDC issue. That is, whether an IDC issue is generated due to the combination of the frequencies configured by the MN 203 and the SN 205. If there is an issue due to the combination of the frequencies configured by the MN 203 and the SN 205, the UE 101 can report the affected frequency combination to either the MN 203 or to the SN 205 as part of an IDC message (for EN-DC) or a UE assistance information (UAI) message (for NR-DC). The entity to report the affected frequency combination to (i.e., the MN 203 or the SN 205 in this example) is determined by the UE 101. Based on which node the UE 101 reports to, that node can take appropriate action as described above with reference to FIGS. 10 and 11.

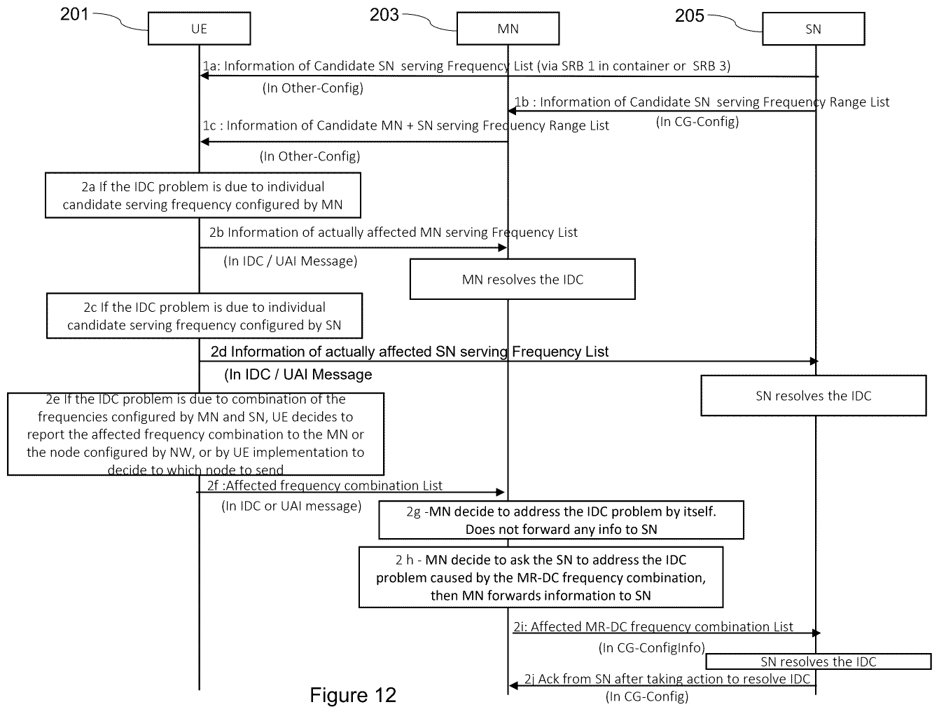

FIG. 12 is a combined communication flow according to an example between a UE, an MN and an SN in a MR-DC scheme where the MN and the SN can configure the UE for FDM when a set of individual frequencies or a combination of frequencies are affected by IDC. In the example of FIG. 12 the MN 203 and the SN 205 separately configure IDC configurations (i.e., candidate serving frequencies) for the UE.

The SN 205 configures the Candidate serving frequency range list for IDC Reporting to SN 205 and transmits (1a) this to the UE 101 (via a signal radio bearer 1 (SRB 1) container or a signal radio bearer 3 (SRB 3)).

In an example, SN 205 may additionally send the candidate serving frequencies to MN 203 (1b).

The MN 203 configures (1c) the Candidate serving frequency range list including a candidate serving frequency decided by the MN 203. The Candidate serving frequency range list configured by the MN 203 can include the candidate serving frequencies forwarded to it by the SN 205. The MN 203 forwards the configured Candidate serving frequency range list to the UE 101.

The UE 201 uses the information from the MN 203 and the SN 205 to determine (2a) whether the individual frequency or combination of frequencies will cause an IDC issue. That is, whether an IDC issue is generated due to the individual or combination of the frequencies configured by the MN 203 and the SN 205.

If the UE 201 detects such an issue, representing an IDC problem, the UE checks (2a) whether the IDC problem is due to individual candidate serving frequencies configured by the MN 203. The UE 101 can report (2b) such individual affected carrier frequencies in an IDC or UAI message to the MN 205 in order to enable the MN 205 to resolve the IDC issue.

The UE can check (2c) whether the IDC problem is due to individual candidate serving frequencies configured by the SN 205. The UE 101 can report (2d) such individual affected carrier frequencies in an IDC or UAI message to the SN 205 using a container in SRB1 or using SRB 3 in order to enable the SN 205 to resolve the IDC issue. Accordingly, as appropriate, the MN 203 or the SN 205 can resolve the IDC issue as described above for example.

If there is an issue due to the combination of the frequencies configured by the MN 203 and the SN 205, the UE 101 can report the affected frequency combination to the MN or the node configured by NW, or decide on its own to which node to send the report to (2e).

If the UE decides to report (2f) the affected frequency combination to the MN 203 as part of an IDC message (for EN-DC) or a UE assistance information (UAI) message (for NR-DC) it can include the affected frequency combination in the report to the MN. If the MN 203 decide to address the IDC problem by itself e.g., by deactivating a Secondary Cell, SCell, of the telecommunications network; and/or, switching to a different carrier bandwidth part, BWP, from a set of multiple available carrier bandwidth parts, BWPs, for uplink and/or downlink communications between the master node, MN, and the user equipment, UE; and/or restricting a physical resource block, PRB, allocation in an unaffected frequency range, then the MN 203 does not forward any information to the SN 205.

However, if the MN 203 decides to have the SN address the IDC problem caused by the MR-DC frequency combination, the MN 203 can forward (2d) information about the MR-DC frequency combination to the SN 205. This means that there is an implicit indication for the SN 205 to act. The SN 205 can then apply an FDM solution to resolve the IDC issue, such as by deactivating a Secondary Cell, SCell, of the telecommunications network; and/or, switching to a different carrier bandwidth part, BWP, from a set of multiple available carrier bandwidth parts, BWPs, for uplink and/or downlink communications between the SN, and the UE; and/or restricting a physical resource block, PRB, allocation in an unaffected frequency range, whereby to resolve the in-device coexistence, IDC, for uplink and/or downlink communications between the master node, MN, and/or the secondary node, SN, and the user equipment, UE. There can also be an explicit indication that an IDC problem is due to a combination of frequencies and only an SN frequency from the combination is forwarded. The SN 205 can resolve the IDC issue and transmit an acknowledgement (2e) to the MN 203.

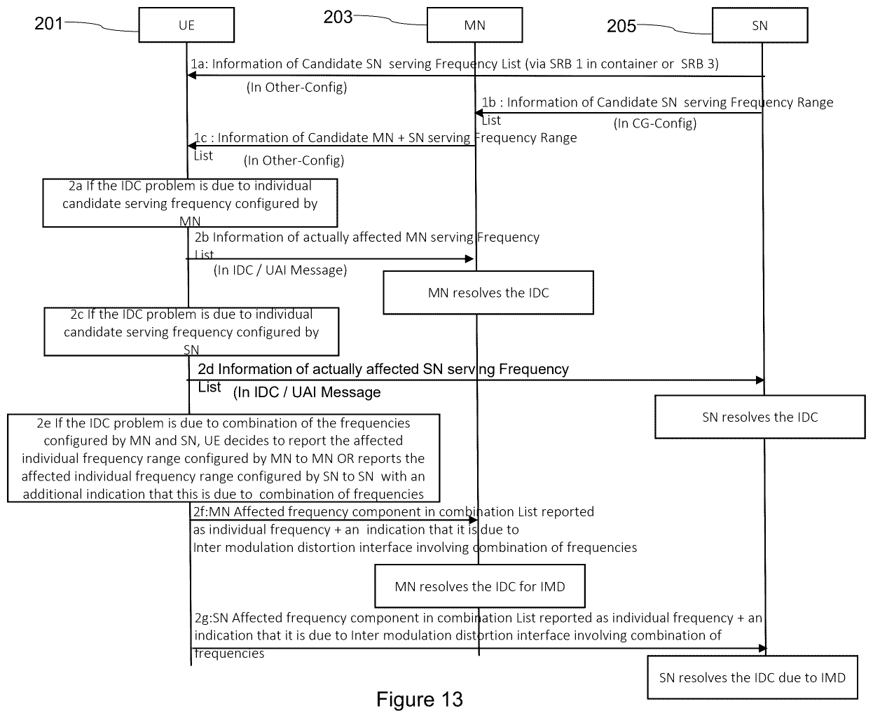

FIG. 13 is a combined communication flow according to an example between a UE, an MN and an SN in a MR-DC scheme where the MN and the SN can configure the UE for FDM when a set of individual frequencies or a combination of frequencies are affected by IDC and the UE reports individual frequencies components from the combinations to either MN or SN; In the example of FIG. 13 the MN 203 and the SN 205 separately configure IDC configurations (i.e., candidate serving frequencies) for the UE.

The SN 205 configures the Candidate serving frequency range list for IDC Reporting to SN 205 and transmits (1a) this to the UE 101 (via a signal radio bearer 1 (SRB 1) container or a signal radio bearer 3 (SRB 3)).

In an example, SN 205 may additionally also send the candidate serving frequencies it is interested in receiving the IDC reports to MN 203 (1b).

The MN 203 configures (1c) the Candidate serving frequency range list including the candidate serving frequency decided by MN and may include the ones forwarded by SN 205 for UE 101 for IDC reporting to MN 203 and forwards this to the UE 101.

The UE 201 uses the information from the MN 203 and the SN 205 to determine (2a) whether the individual frequency or combination of frequencies will cause an IDC issue. That is, whether an IDC issue is generated due to the individual or combination of the frequencies configured by the MN 203 and the SN 205.

If the UE 201 detects such an issue, representing an IDC problem, the UE checks (2a) whether the IDC problem is due to individual candidate serving frequencies configured by the MN 203. The UE 101 can report (2b) such individual affected carrier frequencies in an IDC or UAI message to the MN 205 in order to enable the MN 205 to resolve the IDC issue.

The UE can check (2c) whether the IDC problem is due to individual candidate serving frequencies configured by the SN 205. The UE 101 can report (2d) such individual affected carrier frequencies in an IDC or UAI message to the SN 205 using a container in SRB1 or using SRB 3 in order to enable the SN 205 to resolve the IDC issue. Accordingly, as appropriate, the MN 203 or the SN 205 can resolve the IDC issue as described above for example.

If there is an issue due to the combination of the frequencies configured by the MN 203 and the SN 205, the UE 101 can report the affected individual frequency range configured by MN from the combination to the MN or reports the IDC assistance information including the individual affected frequency range configured by SN in the combination to SN along with an explicit indication that the IDC problem is due to the combination of the frequencies.

Further the node, MN 203 or SN 205 to which the UE 101 can report for such IDC issues arising from the combination of the frequencies may be configured by NW, or decide on its own by the UE (2e).

If the UE decides to report (2f) the affected frequency combination to the MN 203 as part of an IDC message (for EN-DC) or a UE assistance information (UAI) message (for NR-DC) it can include the individual affected frequency from the combination configured by MN in the report to the MN along with an explicit indication that this IDC issue is due to combination of frequencies. The MN 203 can decide to address the IDC problem by e.g., by deactivating a Secondary Cell, SCell, of the telecommunications network; and/or, switching to a different carrier bandwidth part, BWP, from a set of multiple available carrier bandwidth parts, BWPs, for uplink and/or downlink communications between the master node, MN, and the user equipment, UE; and/or restricting a physical resource block, PRB, allocation in an unaffected frequency range.

If the UE decides to report (2g) the affected frequency combination to the SN 205 as part of an IDC message (for EN-DC) or a UE assistance information (UAI) message (for NR-DC) it can include the individual affected frequency from the combination configured by SN in the report to the SN along with an explicit indication that this IDC issue is due to combination of frequencies. The SN 205 can decide to address the IDC problem by e.g., by deactivating a Secondary Cell, SCell, of the telecommunications network; and/or, switching to a different carrier bandwidth part, BWP, from a set of multiple available carrier bandwidth parts, BWPs, for uplink and/or downlink communications between the secondary node, SN, and the user equipment, UE; and/or restricting a physical resource block, PRB, allocation in an unaffected frequency range.

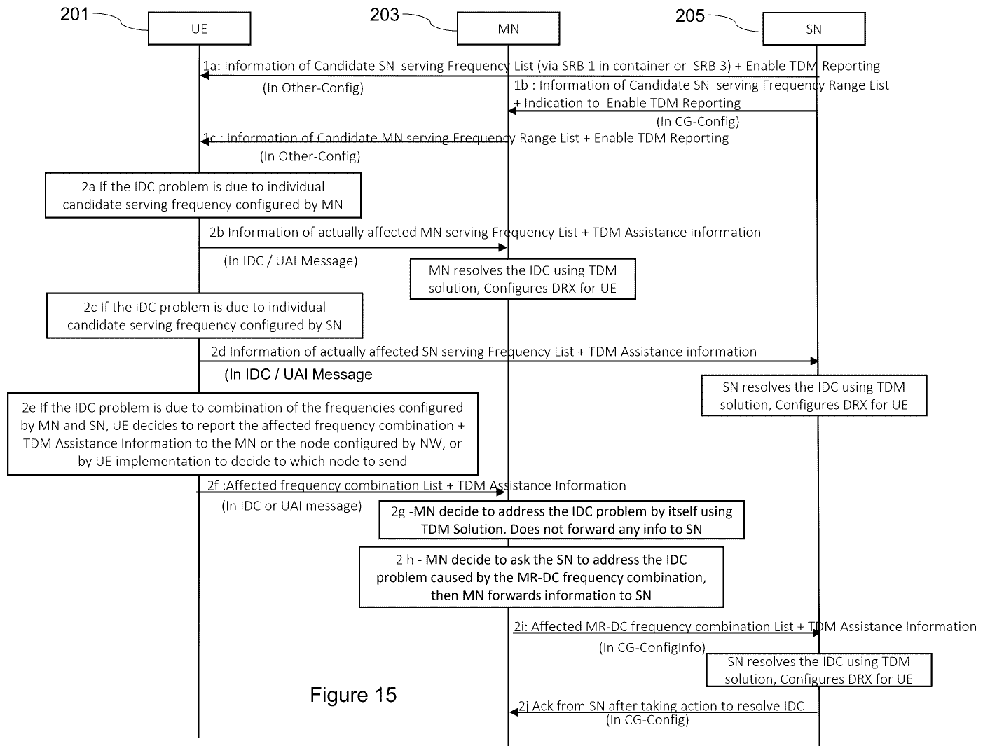

FIG. 15 is a combined communication flow according to an example between a UE, an MN and an SN in a MR-DC scheme where the MN and the SN can configure the UE for FDM and TDM when a set of individual frequencies or a combination of frequencies are affected by IDC. In the example of FIG. 15 the MN 203 and the SN 205 separately configure IDC configurations (i.e., candidate serving frequencies and enable TDM reporting) for the UE.

The SN 205 configures the Candidate serving frequency range list and enables TDM report for IDC Reporting to SN 205 and transmits (1a) this to the UE 101 (via a signal radio bearer 1 (SRB 1) container or a signal radio bearer 3 (SRB 3)).

In an example, SN 205 additionally send the candidate serving frequencies and indication to enable TDM reporting to MN 203 (1b).

The MN 203 configures (1c) the Candidate serving frequency range list including a candidate serving frequency decided by the MN 203 and also enables TDM reporting. The Candidate serving frequency range list configured by the MN 203 can include the candidate serving frequencies forwarded to it by the SN 205. The MN 203 forwards the configured Candidate serving frequency range list to the UE 101 and also enables TDM reporting.

The UE 201 uses the information from the MN 203 and the SN 205 to determine (2a) whether the individual frequency or combination of frequencies will cause an IDC issue. That is, whether an IDC issue is generated due to the individual or combination of the frequencies configured by the MN 203 and the SN 205.

If the UE 201 detects such an issue, representing an IDC problem, the UE checks (2a) whether the IDC problem is due to individual candidate serving frequencies configured by the MN 203. The UE 101 can report (2b) such individual affected carrier frequencies in an IDC or UAI message to the MN 205 along with the TDM Assistance information in order to enable the MN 205 to resolve the IDC issue. MN may then resolve the IDC using TDM solution and configures appropriate DRX for UE based on the TDM assistance information received from the UE.

The UE can check (2c) whether the IDC problem is due to individual candidate serving frequencies configured by the SN 205. The UE 101 can report (2d) such individual affected carrier frequencies in an IDC or UAI message along with the TDM Assistance information to the SN 205 using a container in SRB1 or using SRB 3 in order to enable the SN 205 to resolve the IDC issue. SN may then resolve the IDC using TDM solution and configures appropriate DRX for UE based on the TDM assistance information received from the UE. Accordingly, as appropriate, the MN 203 or the SN 205 can resolve the IDC issue as described above for example.

If there is an issue due to the combination of the frequencies configured by the MN 203 and the SN 205, the UE 101 can report the affected frequency combination to the MN or the node configured by NW, or decide on its own to which node to send the report to (2e).

If the UE decides to report (2f) the affected frequency combination to the MN 203 as part of an IDC message (for EN-DC) or a UE assistance information (UAI) message (for NR-DC) it can include the affected frequency combination in the report to the MN along with the TDM Assistance information. If the MN 203 decide to address the IDC problem by itself using TDM solution and it configures appropriate DRX for the UE, then the MN 203 does not forward any information to the SN 205.

If the MN 203 knows that the SN 205 support the TDM solution for IDC and decides to have the SN address the IDC problem caused by the MR-DC frequency combination, the MN 203 can forward (2d) information about the MR-DC frequency combination and the TDM Assistance information to the SN 205. This means that there is an implicit indication for the SN 205 to act. The SN 205 can then apply an TDM solution to resolve the IDC issue, such as by configuring appropriate DRX for the UE, whereby to resolve the in-device coexistence, IDC There can also be an explicit indication that an IDC problem is due to a combination of frequencies and only an SN frequency from the combination is forwarded along with TDM Assistance information. The SN 205 can resolve the IDC issue and transmit an acknowledgement (2e) to the MN 203.

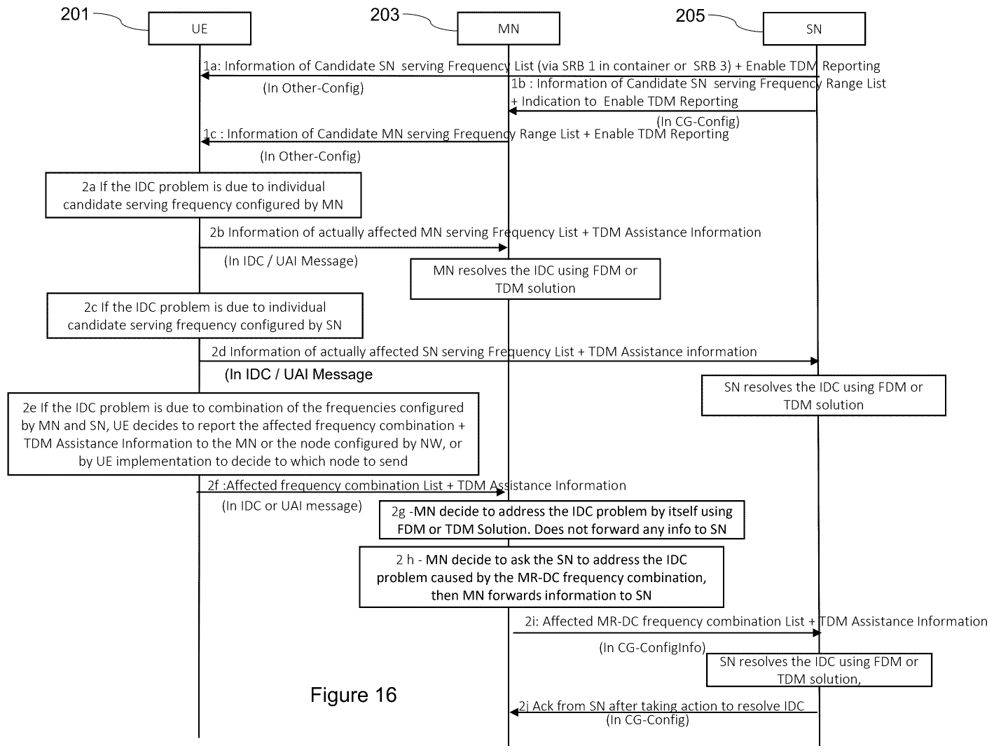

FIG. 16 is a generalised communication flow according to an example between a UE, an MN and an SN in a MR-DC scheme where the MN and the SN can configure the UE for FDM and TDM when a set of individual frequencies or a combination of frequencies are affected by IDC. In the example of FIG. 16 the MN 203 and the SN 205 separately configure IDC configurations (i.e., candidate serving frequencies and enable TDM reporting) for the UE.

The SN 205 configures the Candidate serving frequency range list and enables TDM report for IDC Reporting to SN 205 and transmits (1a) this to the UE 101 (via a signal radio bearer 1 (SRB 1) container or a signal radio bearer 3 (SRB 3)).

In an example, SN 205 additionally send the candidate serving frequencies and indication to enable TDM reporting to MN 203 (1b).

The MN 203 configures (1c) the Candidate serving frequency range list including a candidate serving frequency decided by the MN 203 and also enables TDM reporting. The Candidate serving frequency range list configured by the MN 203 can include the candidate serving frequencies forwarded to it by the SN 205. The MN 203 forwards the configured Candidate serving frequency range list to the UE 101 and also enables TDM reporting.

The UE 201 uses the information from the MN 203 and the SN 205 to determine (2a) whether the individual frequency or combination of frequencies will cause an IDC issue. That is, whether an IDC issue is generated due to the individual or combination of the frequencies configured by the MN 203 and the SN 205.

If the UE 201 detects such an issue, representing an IDC problem, the UE checks (2a) whether the IDC problem is due to individual candidate serving frequencies configured by the MN 203. The UE 101 can report (2b) such individual affected carrier frequencies in an IDC or UAI message to the MN 205 along with the TDM Assistance information in order to enable the MN 205 to resolve the IDC issue. MN may then resolve the IDC using FDM or TDM solution.

The UE can check (2c) whether the IDC problem is due to individual candidate serving frequencies configured by the SN 205. The UE 101 can report (2d) such individual affected carrier frequencies in an IDC or UAI message along with the TDM Assistance information to the SN 205 using a container in SRB1 or using SRB 3 in order to enable the SN 205 to resolve the IDC issue. SN may then resolve the IDC using FDM or TDM solution. Accordingly, as appropriate, the MN 203 or the SN 205 can resolve the IDC issue as described above for example.

If there is an issue due to the combination of the frequencies configured by the MN 203 and the SN 205, the UE 101 can report the affected frequency combination to the MN or the node configured by NW, or decide on its own to which node to send the report to (2e).

If the UE decides to report (2f) the affected frequency combination to the MN 203 as part of an IDC message (for EN-DC) or a UE assistance information (UAI) message (for NR-DC) it can include the affected frequency combination and the TDM assistance information in the report to the MN. If the MN 203 decide to address the IDC problem by itself using FDM solution e.g., by deactivating a Secondary Cell, SCell, of the telecommunications network; and/or, switching to a different carrier bandwidth part, BWP, from a set of multiple available carrier bandwidth parts, BWPs, for uplink and/or downlink communications between the master node, MN, and the user equipment, UE; and/or restricting a physical resource block, PRB, allocation in an unaffected frequency range; or by itself using TDM solution by configuring appropriate DRX to the UE, then the MN 203 does not forward any information to the SN 205.

If the MN 203 knows that the SN 205 support the TDM solution for IDC and decides to have the SN address the IDC problem caused by the MR-DC frequency combination, the MN 203 can forward (2d) information about the MR-DC frequency combination and the TDM Assistance information to the SN 205. This means that there is an implicit indication for the SN 205 to act. The SN 205 can then apply an FDM solution to resolve the IDC issue, such as by deactivating a Secondary Cell, SCell, of the telecommunications network; and/or, switching to a different carrier bandwidth part, BWP, from a set of multiple available carrier bandwidth parts, BWPs, for uplink and/or downlink communications between the SN, and the UE; and/or restricting a physical resource block, PRB, allocation in an unaffected frequency range; or apply TDM solution to by configuring appropriate DRX for the UE whereby to resolve the in-device coexistence, IDC, for uplink and/or downlink communications between the master node, MN, and/or the secondary node, SN, and the user equipment, UE. There can also be an explicit indication that an IDC problem is due to a combination of frequencies and only an SN frequency from the combination is forwarded along with TDM Assistance information. The SN 205 can resolve the IDC issue and transmit an acknowledgement (2e) to the MN 203.

Accordingly, there are presented various solutions for addressing an IDC problem in MR-DC scenarios along with the configuration and solution aspects in terms of which nodes provide a configuration and how an FDM or a TDM solution can be applied with internode coordination.

Examples in the present disclosure can be provided as procedures, methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a machine such as a general-purpose computer, a platform comprising user equipment such as a smart device, e.g., a smart phone, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode. For example, the instructions may be provided on a non-transitory computer readable storage medium encoded with instructions, executable by a processor.

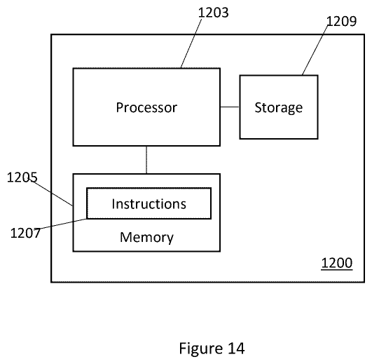

FIG. 14 is a schematic representation of a machine according to an example. The machine 1200 can be, e.g., a system or apparatus, user equipment, or part thereof (e.g., the UE of FIG. 1, a MN 203, or a SN 205). The machine 1200 comprises a processor 1203, and a memory 1205 to store instructions 1207, executable by the processor 1203. The machine comprises a storage 1209 that can be used to store data representing configurations for FDM and/or TDM patterns as described above with reference to FIGS. 1 to 11 for example.

The machine 1200 can implement a method for mitigating in-device coexistence between multiple radio transceivers implementing multiple radio communication protocols for a UE configured to operate in dual connectivity, DC, with a master node, MN, and a secondary node, SN, of a telecommunications network such that the UE can transmit and receive data on multiple component carriers of the MN and the SN.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer or software product, such as a non-transitory machine-readable storage medium, the computer software or product being stored in a storage medium and comprising a plurality of instructions, e.g., machine readable instructions, for making a computer device implement the methods recited in the examples of the present disclosure.

In some examples, some methods can be performed in a cloud-computing or network-based environment. Cloud-computing environments may provide various services and applications via the Internet. These cloud-based services (e.g., software as a service, platform as a service, infrastructure as a service, etc.) may be accessible through a web browser or other remote interface of the user equipment for example. Various functions described herein may be provided through a remote desktop environment or any other cloud-based computing environment.

While various embodiments have been described and/or illustrated herein in the context of fully functional computing systems, one or more of these exemplary embodiments may be distributed as a program product in a variety of forms, regardless of the particular type of computer-readable-storage media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein. In addition, one or more of the modules described herein may transform data, physical devices, and/or representations of physical devices from one form to another.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

1-13. (canceled)

14. An apparatus, comprising:
at least one processor; and
at least one memory, wherein the at least one memory stores instructions, and when the at least one processor executes the instructions stored in the at least one memory, the apparatus executes operations comprising:
receiving, from a user equipment (UE), data representing an indication of a set of carrier frequencies, a set of carrier frequency ranges, or a combination of candidate serving frequencies or candidate service frequency ranges affected by in-device coexistence (IDC); and
using a configuration corresponding to the data, for time division multiplexing (TDM) or frequency division multiplexing (FDM) to mitigate effects of the IDC.

15. The apparatus according to claim 14, wherein when the at least one processor executes the instructions stored in the at least one memory, the apparatus executes further operations comprising:
transmitting, to a secondary node (SN), the data representing the indication of the set of carrier frequencies, the set of carrier frequency ranges, or the combination of candidate serving frequencies or candidate serving frequency ranges.

16. The apparatus according to claim 14, wherein the configuration is determined, by a secondary node, based on the data received from the UE, wherein the apparatus is a master node (MN).

17. The apparatus according to claim 16, wherein when the at least one processor executes the instructions stored in the at least one memory, the apparatus executes further operations comprising:
transmitting, to a secondary node (SN), the data representing the indication of the set of carrier frequencies, the set of carrier frequency ranges, or the combination of candidate serving frequencies or candidate serving frequency ranges.

18. The apparatus according to claim 14, wherein the set of carrier frequencies or the set of carrier frequency ranges is configured by the apparatus.

19. The apparatus according to claim 18, wherein when the at least one processor executes the instructions stored in the at least one memory, the apparatus executes further operations comprising:
transmitting, to a secondary node (SN), the data representing the indication of the set of carrier frequencies, the set of carrier frequency ranges, or the combination of candidate serving frequencies or candidate serving frequency ranges.

20. The apparatus according to claim 19, wherein the set of carrier frequencies, the set of carrier frequency ranges, or a combination of candidate serving frequencies or candidate serving frequency ranges is configured by the SN.

21. The apparatus according to claim 14, wherein when the at least one processor executes the instructions stored in the at least one memory, the apparatus executes further operations comprising:
receiving, from a secondary node (SN), data representing an indication to enable TDM; and
transmitting, to the SN, TDM assistance information comprising at least one TDM pattern.

22. A method, applied to a master node (MN), comprising:
receiving, from a user equipment (UE), data representing an indication of a set of carrier frequencies, a set of carrier frequency ranges, or a combination of candidate serving frequencies or candidate serving frequency ranges, affected by in-device coexistence (IDC); and
using a configuration corresponding to the data, for time division multiplexing (TDM), or frequency division multiplexing (FDM) to mitigate effects of the IDC.

23. The method according to claim 22, wherein the configuration is determined, by a secondary node (SN), based on the data received from the UE.

24. The method according to claim 22, wherein the set of carrier frequencies or the set of carrier frequency ranges is configured by the MN.

25. The method according to claim 22, further comprising:
transmitting, to a secondary node (SN), the data representing the indication of the set of carrier frequencies, the set of carrier frequency ranges, or a combination of candidate serving frequencies or candidate serving frequency ranges.

26. The method according to claim 25, wherein the set of carrier frequencies, the set of carrier frequency ranges, or the combination of candidate serving frequencies or candidate serving frequency ranges is configured by the SN.

27. The method according to claim 22, further comprising:
receiving, from a secondary node (SN), data representing an indication to enable TDM; and
transmitting, to the SN, TDM assistance information comprising at least one TDM pattern.

28. An apparatus, comprising:
at least one processor; and
at least one memory, wherein the at least one memory stores instructions, and when the at least one processor executes the instructions stored in the at least one memory, the apparatus executes operations comprising:
receiving, from a master node (MN), a first set of data representing a first set of candidate carrier frequencies or a first candidate serving frequency range list;
receiving, from a secondary node (SN), a second set of data representing a second set of candidate carrier frequencies or a second candidate serving frequency range list;
detecting in-device coexistence (IDC) based on the first set of data or the second set of data; and
transmitting data to the MN or to the SN representing an indication of the IDC.

29. The apparatus according to claim 28, wherein when the at least one processor executes the instructions stored in the at least one memory, the apparatus executes further operations comprising:
receiving, from the MN, data indicating the UE to report, to the MN, the data representing the indication of the IDC.

30. The apparatus according to claim 28, wherein when the at least one processor executes the instructions stored in the at least one memory, the apparatus executes further operations comprising:
receiving, from the MN, data indicating the UE to report, to the SN, the data representing the indication of the IDC.
